(19) United States
(12) Patent Application Publication
(10) Pub. No.: US 2026/0097424 A1
(43) Pub. Date: Apr. 9, 2026

(54) CLEANING A PROJECTILE CASING

(71) Applicant: Mannis Operations LLC, Jupiter, FL (US)

(72) Inventor: Jeffrey Citron, Jupiter, FL (US)

(21) Appl. No.: 18/909,053

(22) Filed: Oct. 8, 2024

(51) Int. Cl. B08B 9/032; B08B 5/02; B08B 13/00; B08B 15/02; B08B 15/04; F42B 33/04; F42B 33/14

(52) U.S. Cl. CPC B08B 9/0325; B08B 5/02; B08B 13/00; B08B 15/02; B08B 15/04; F42B 33/04; F42B 33/14; B08B 2209/032

(57) ABSTRACT

An apparatus, system, computer-readable medium, process, or combination thereof to clean and/or modify a projectile casing using compressed air. For example, compressed air can be used to remove carbon or otherwise modify a projectile casing. A user, programmer, or control can select, adjust, or otherwise determine a setting of compressed air, such as an amount of pressure based, at least in part, on a casing type and/or how dirty a projectile casing appears (e.g., in images or upon visual inspection). A method to select an air compression setting to use with a type of projectile casing.

### CROSS REFERENCE TO RELATED APPLICATION

This application incorporates by reference for all purposes the full disclosure of co-pending U.S. patent application Ser. No. ______, filed concurrently herewith, entitled “SEATING OF A PRIMER” (Attorney Docket No. 0117454-005US0). This application incorporates by reference for all purposes the full disclosure of U.S. patent application Ser. No. 18/385,336, entitled “MODIFYING A PROJECTILE CASING,” filed Oct. 30, 2023, U.S. patent application Ser. No. 18/385,339, entitled “COMPENSATING FOR TEMPERATURE OF A BARREL IN BALLISTICS,” filed Oct. 30, 2023, and U.S. patent application Ser. No. 18/385,341, entitled “COMPENSATING FOR PROJECTILE WEIGHT IN BALLISTICS,” filed Oct. 30, 2023, the entire contents of which are incorporated herein by reference.

### TECHNICAL FIELD

An apparatus, system, device, computer-readable medium, and/or process to clean and/or modify physical attributes of a projectile casing using air (e.g., compressed air) to improve metrics, such as consistency, shape, and residue amount on the modified projectile casing. For example, a bullet casing that has low residue (e.g., zero, minimal, or desired amount masking casing imperfections) and is circular, symmetrical, smooth, and consistent likely results in a shooter having a more predictable shot and better aim than a bullet casing that has residue, or is asymmetrical or has defects in it.

### BACKGROUND

Ballistics includes the science of projectiles and firearms, such as the motion of objects (e.g., rounds of projectiles) that are driven forward. For example, ballistics includes the study of effects of firing a round for a projectile, where the round comprises a cartridge including a casing and the projectile (e.g., bullet, slug, or shot). There are many factors to consider when a firearm prepares a projectile to be fired and/or fires a projectile according to ballistics. For example, a size and shape of a projectile casing, which holds a projectile, can affect how a projectile behaves when fired. As another example, the exit speed of the bullet from a barrel, the shape of the bullet, the size of the bullet, and the material of the bullet can affect the round's trajectory. Also, properties of the barrel such as length, material, width, and design can affect the firing of a round, impacting the result. These are various factors a marksman can consider while preparing a projectile to be fired and/or aiming. However, a marksman can still consider these factors and have performance affected (e.g., missing a target, having less accuracy and/or consistency). Accordingly, there exists a need to improve preparing a projectile to be fired and/or firing a round of a projectile.

### BRIEF DESCRIPTION OF THE DRAWINGS

FIGS. 1A-1D illustrate a schematic diagram of a system for cleaning and/or modifying a projectile casing using compressed air, in accordance with at least one embodiment;

FIGS. 2A and 2B illustrate a schematic and cross-sectional view for a system to remove a primer from a projectile casing, in accordance with at least one embodiment;

FIGS. 3A and 3B illustrate a schematic and cross-sectional view diagram of a system removing a primer from a projectile casing, in accordance with at least one embodiment;

FIGS. 4A and 4B illustrate a schematic and cross-sectional view diagram of a system to use compressed air to clean a projectile casing, in accordance with at least one embodiment;

FIGS. 5, 6A, and 6B illustrate cross-sectional views of a system to use compressed air to clean and/or modify a projectile casing, in accordance with at least one embodiment;

FIG. 7 illustrates a schematic diagram of a system including controls to clean and/or modify a casing, in accordance with at least one embodiment;

FIGS. 8A-8C illustrate cross-sectional views of a system to use compressed air to clean carbon from a casing, in accordance with at least one embodiment;

FIG. 9A illustrates a cross-sectional view of a debris trap, in accordance with at least one embodiment;

FIG. 9B illustrates a cross-sectional view of a debris trap, in accordance with at least one embodiment;

FIG. 9C illustrates a schematic diagram of a filter trapping debris, in accordance with at least one embodiment;

FIG. 10 illustrates a cross-sectional and schematic view of a system for cleaning a projectile casing with compressed air, in accordance with at least one embodiment;

FIGS. 11A-11C illustrate schematic and a cross-sectional view of a system to remove a cleaned and/or modified casing, in accordance with at least one embodiment;

FIGS. 12A-12C illustrate cross-sectional views of system to clean a casing using a rod, in accordance with at least one embodiment; and

FIG. 13 illustrates a process flow diagram for cleaning and/or modifying a projectile casing using compressed air, in accordance with at least one embodiment.

### DETAILED DESCRIPTION

There are many considerations when choosing a method of cleaning a projectile casing to house, support, or otherwise position a projectile. As an example, a type (e.g., size, manufacturer, diameter, shape) of projectile casing may be designed specific to a type of projectile (e.g., bullet, slug, and/or shot), an amount of powder to be used to fire a projectile, and/or a type of firearm to fire a projectile. When a projectile casing is fired, residue may be left on the projectile casing from ignited powder. An amount of residue or how a residue is distributed may vary by a type of projectile casing (e.g., casing corresponding to a type of projectile, amount of powder, or a type of primer), which may require different amounts of cleaning to reach a desired amount of residue remaining on the projectile casing. In some instances, it is desired to leave some residue on a projectile casing prior to reloading a projectile casing with a new projectile. As an example, leaving a small amount residue specific to a type of projectile casing being used could mask small irregularities in the brass of the projectile casing left over from its previous use. However, a current method of tumbling the brass may remove too much residue and, thus, an amount of residue to remain in a casing is likely not adjustable to a type of projectile casing. As another example, it may be preferred to clean most (e.g., all) residue on a projectile casing before using it again.

There are other uses as well to tailoring an amount of cleaning to an attribute of a projectile casing. An attribute of a projectile casing can include a type, a caliber, how many times a projectile casing has been used, material included in or used to make the projectile casing, dimensions of the projectile casing, size of the projectile casing, how damaged the projectile casing is, how dirty the projectile is, or other physical property of the projectile casing. A marksman may perform loading (e.g., unused brass) and/or reloading (e.g., previously used) of a projectile in a projectile casing, where each may benefit from a desired amount of cleaning. For example, cleaning unused brass could remove debris from manufacturing or storage. As another example, a marksman may use a projectile casing at least once to reach a desired amount of residue on a projectile casing to create precision ammunition and wish to adjust an amount of cleaning to a type of projectile casing. Marksmen may also wish to clean a projectile casing to perform reloading in large batches, such as to reduce an amount of resources (e.g., time and/or expense) used. A desired amount of debris to be removed may be up to a total amount of debris located in a projectile casing, such as all debris or a preferred amount specific to a type of projectile casing to create consistent firing of a projectile.

In at least one embodiment, residue on a projectile casing (e.g., bullet projectile casing) after it is fired, commonly known as “gunshot residue” (GSR), includes a combination of microscopic particles that are expelled when artillery (e.g., firearms) discharges. This residue can include lead, antimony, and barium, which are byproducts of the primer and propellant used in ammunition. For example, when the bullet is fired, the explosion that propels the bullet out of the projectile casing also causes the primer and propellant to vaporize, and as the gases cool, they condense into tiny particles that settle on nearby surfaces, including the bullet projectile casing (e.g., flash-hole). Furthermore, this residue may include a byproduct of the combustion of a propellant within a projectile casing. The thickness of this residue can be in the range of a few micrometers, making it barely visible to the naked eye without magnification.

When observed under a microscope, these particles can appear as small, spherical particles, often clustered together, with a metallic sheen. The composition of the residue can vary depending on the specific type of propellant and/or primer mixture used, but it generally includes lead styphnate, barium nitrate, and antimony sulfide, which are key components in the primer mixture.

In at least one embodiment, residue can be generated as a result of the chemical reactions that occur when the firearm is discharged. For example, the ignition of the primer leads to a rapid combustion of the propellant, which generates high-pressure gases that force the bullet out of the projectile casing and down the barrel. The byproducts of this combustion, along with unburnt particles of the primer and propellant, are ejected from the firearm along with the bullet, leading to the deposition of residue on the projectile casing and surrounding areas.

In at least one embodiment, reusing a bullet projectile casing with residue still present can present consequences, impacting both the performance of the ammunition and the safety of the shooter. The residue can interfere with the proper seating of the new primer and bullet, leading to issues such as incomplete ignition or misfires. This interference may cause the bullet to fire with reduced force or fail to fire altogether, resulting in inconsistent ballistics and accuracy problems. Additionally, in at least one embodiment, residue buildup inside the projectile casing, particularly in the primer pocket or around the neck, can obstruct the proper flow of gases when the firearm is discharged, potentially increasing pressure within the projectile casing, where this increase in pressure can lead to failures like case head separation or even projectile casing rupture, posing a risk of damage to the firearm and injury to the shooter. As another example, residue can also make the reloading process more difficult, as it may cause the projectile casing to stick in the reloading dies or require extra cleaning steps, complicating the process and leading to inconsistencies in the reloaded ammunition. Furthermore, the chemical composition of the residue can lead to corrosion of the brass projectile casing over time, weakening its structural integrity and increasing the likelihood of failure in subsequent firings. Finally, if the residue is not thoroughly cleaned, it can contaminate reloading equipment and other ammunition, spreading issues across multiple rounds. These potential risks highlight the importance of thoroughly cleaning bullet projectile casings before reuse to ensure safe and reliable ammunition.

A round for a projectile includes a cartridge, further comprising a projectile casing and the projectile (e.g., bullet, slug, and/or shot). A projectile casing can be a component of a cartridge that provides the cartridge with its shape and serves as a housing for other functional components. For example, a projectile casing provides a container for propellant powders (e.g., gun powder), serves as a protective shell, and provides support for holding and securing a bullet. A projectile casing can be configured to hold a bullet until it is fired. A projectile casing can be referred to as “brass” (e.g., after a gun is fired, the brass of the projectile casing is expelled and can be reloaded to create another cartridge) or a “shell projectile casing.” A projectile casing can be comprised of or include metal such as brass, aluminum, steel, brass-plated, nickel-plated brass, polymer plastics, 3-dimensional (3D) printing materials, and/or combinations thereof. A projectile casing can be included in a cartridge, which can be a unit of ammunition made up of a cartridge case, primer (e.g., rimfire or centerfire), powder, and a projectile (e.g., bullet, slug, and/or shot). A cartridge can also be referred to as a “round” or “load.” A case can include different shapes and be configured to secure different types of bullets. For example, a bullet projectile casing can have an opening to hold and receive a bullet, bands made from different material that wrap around a projectile casing (e.g., to provide fortifying strength).

A projectile casing (also referred to as a “casing”) can have several purposes. A projectile casing can hold, secure, or otherwise position a bullet sufficiently to ensure that it does not get pushed back when the round is chambered and grip it long enough for the pressure inside to build to the required level when the powder charge is ignited by the primer. A bullet projectile casing can fit in a chamber of a barrel (e.g., both before and after firing), so that it can be chambered and extracted (e.g., expelled) without resistance. A projectile casing can attach to the projectile (e.g., bullet and/or shot) at a front end of a cartridge [e.g., cartridges designed for pistols, rifles (semi-automatic or automatic), shotguns, guns (to include artillery)] or inside of a cartridge (e.g., wadding/sabot containing either a number of shot or an individual slug for a shotgun shell). Embodiments, when describing an implementation for a cartridge for a bullet projectile casing, may also be used in an implementation of reforming brass of an expelled shotgun shell to be reloaded with a slug or shot. A projectile (e.g., bullet, slug, or shot) casing can align a projectile with a barrel bore to the front, hold primer (e.g., centerfire boxer, centerfire berdan, or rimfire) at a back end, which receives an impact from a firing pin, and be responsible for igniting the main propellant charge inside the case.

The projectile casing may be designed for a single use, for more than one use (e.g., be reloadable), or both. Projectile casings can be acquired separate from the bullet, such as for hand-loading (e.g., self-loading to perform precision shooting), and/or be reloadable once fired and expelled from a barrel. For example, projectile casings which can receive a replaceable primer include centerfire primers.

In order to load a projectile into a case, the projectile is seated into a projectile casing, such as in the instance of reloading (though it may also be used in preparation of self-loading a projectile). If a previously expended round (e.g., shot by a gun) used a projectile casing, the projectile casing may have expanded beyond a desired projectile casing diameter or acquired a defect (e.g., donut, misshaped hole, incorrect thickness) needing to be cleaned prior to being reshaped. For example, a projectile casing is typically a small amount narrower than the bullet diameter to create a secure fit (e.g., semi-tight, tight, clamped fit), where the bullet itself may be held in position by friction from the bullet projectile casing. For example, a projectile casing can be a small amount narrower than the bullet itself (e.g., if the bullet has a section that is 0.38 inches in diameter that is supposed to be inserted into a projectile casing, the projectile casing can be, e.g., 0.379, 0.378, 0.375, or 0.37 inches) and when the bullet is seated, the bullet is fit into the brass.

However, once a projectile casing has been used (e.g., when a projectile has been fired) residue remains from the propellant and/or primer mixture. The projectile casing may also have small irregularities from being previously fired such that a small amount of residue could assist with smoothing these flaws. Yet, brass shards and other debris still may need to be removed prior to reloading the projectile casing with at least the primer, powder, and projectile.

The disclosed technology here can include cleaning of a projectile casing using compressed air. For example, a projectile casing may be held in a device, such that controls allow an amount of compressed air to enter a projectile casing with an amount of pressure (e.g., pounds per square inch (psi)) and at a direction to remove debris from the projectile casing in a debris catch (e.g., trap). In at least one embodiment, an automated system places a projectile system in a container, which may generate a vacuum, and applies (e.g., blows, directs, generates) air flow on a projectile casing.

While measurements of projectiles and projectile casings are provided in this application in inches, they can also be provided in millimeters or another measuring system. Also, the disclosed technology disclosed herein can be applied to bullets of different sizes, shapes, and designs as well as to projectile casings with different sizes, shapes, and designs (e.g., an operator would change the mandrel, change the die, or change the interior parts of the die for a desired outcome, size, or shape of the projectile casing). The brass, being a soft metal, can have the projectile seated into the projectile casing this way. The projectile casing is narrow enough to be seated in the action of the firearm, but the rim of the projectile casing is wide enough such that the projectile casing will not pass down the length of the barrel.

However, in preparation of loading a projectile into a case, a projectile casing may need an amount of debris removed (such as to perform self-loading in precision shooting). If any irregularities are present, such as due to unwanted debris or misshaped brass, a projectile casing may cause the gas, when firing a round, to unevenly distribute across a projectile and impact the spin and trajectory of the projectile. As an example, a marksman may want an amount of cleaning of a projectile casing increased if unwanted debris is present. As another example, if irregularities (e.g., scratches, dents, and/or inconsistencies) are present in the brass of the projectile casing an amount of residue may be desired, such that an amount of cleaning is decreased until at least the unwanted debris is removed. Also, such as in the mass-production of projectile casings by manufacturers, it is possible a projectile casing has debris present from remaining in storage, in which case it may need to be confirmed that any unwanted debris has been removed. An amount of cleaning may be adjusted to a type of projectile casing (e.g., which may include a type pertaining to the projectile casing's previous use) by adjusting an amount of pressure of compressed air, a length of time exposed to compressed air, and/or a direction compressed air enters a projectile casing. An amount of cleaning may be adjusted depending on an attribute of the projectile casing.

An apparatus, system, computer-readable medium, computer-implemented method, and/or process to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

In at least one embodiment, the disclosed technology includes a method of cleaning a projectile casing (e.g., projectile case). The method can be performed by a human, machine, or a combination thereof. The method can at least include: selecting an air compression setting to use with a type of projectile casing, inserting a projectile casing into a device, releasing compressed air into a projectile casing at a selected setting, catching debris exiting a projectile casing, removing a projectile casing, and/or combinations thereof. The disclosed technology can be used for cartridges designed for different types of projectiles, such as those fired by gun (e.g., of a particular caliber or gauge), though the disclosed technology may also be used for other guns, such as projectile cartridges for artillery. A type of gun can impact ballistics associated with firing a bullet and may require differing amounts of gun powder. A gun can be any type of firearm used by an individual, such as a handgun (e.g., pistol), shotgun (e.g., slugs or shot), or rifle (semi-automatic or automatic). A gun may also include crew-served equipment to fire a projectile from a barrel, such as artillery or naval guns. In some embodiments, the disclosed technology works with projectile casing for guns (e.g., rifles) used for precision shooting (e.g., long range).

Example embodiments are described herein with reference to the accompanying drawings. The figures are not necessarily drawn to scale. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It should also be noted that as used herein and in the appended claims, the singular forms “a,” “an,” and “the” include plural references unless the context clearly dictates otherwise.

In the following description, various working examples are provided for illustrative purposes. However, it is to be understood the present disclosure may be practiced without one or more of these details. Reference will now be made in detail to non-limiting examples of this disclosure, examples of which are illustrated in the accompanying drawings. The examples are described below by referring to the drawings, wherein like reference numerals refer to like elements. When similar reference numerals are shown, corresponding description(s) are not repeated, and the interested reader is referred to the previously discussed figure(s) for a description of the like element(s).

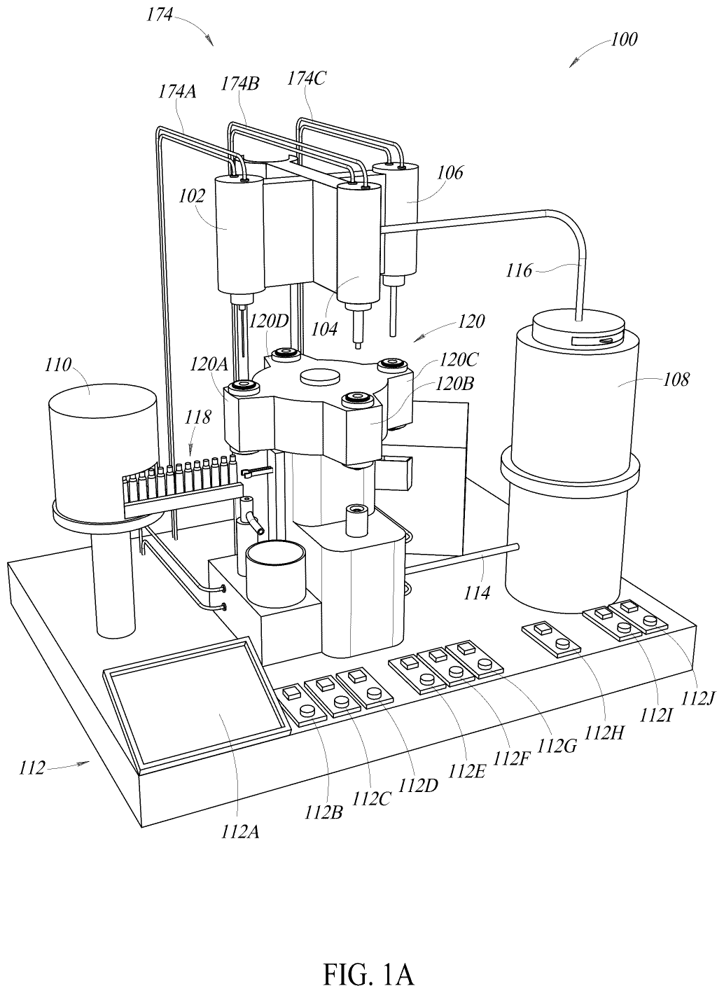

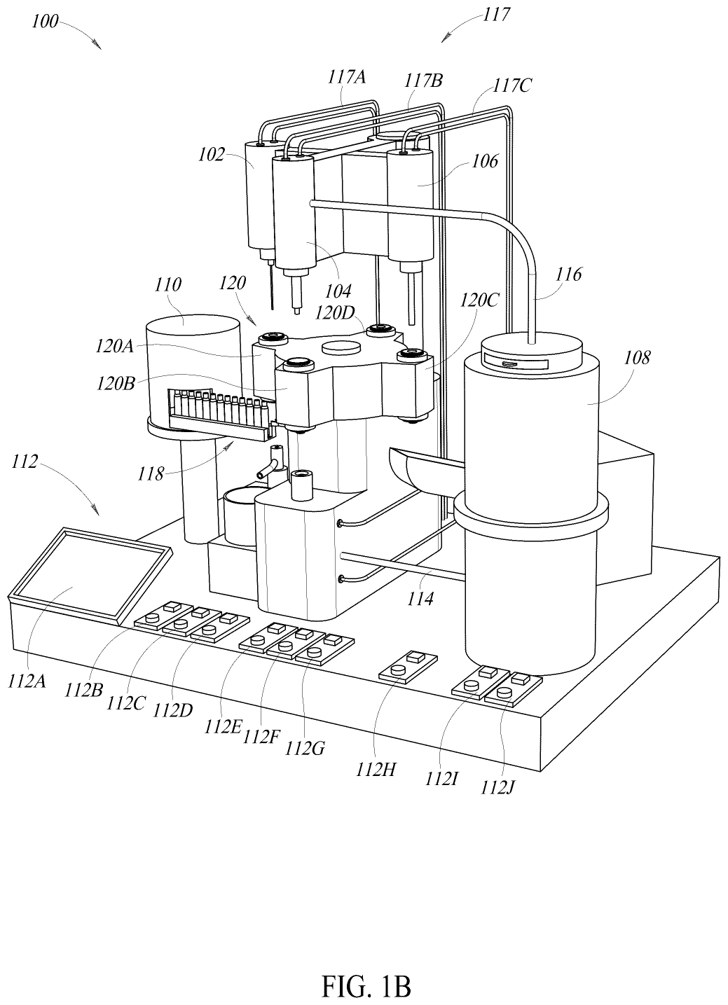

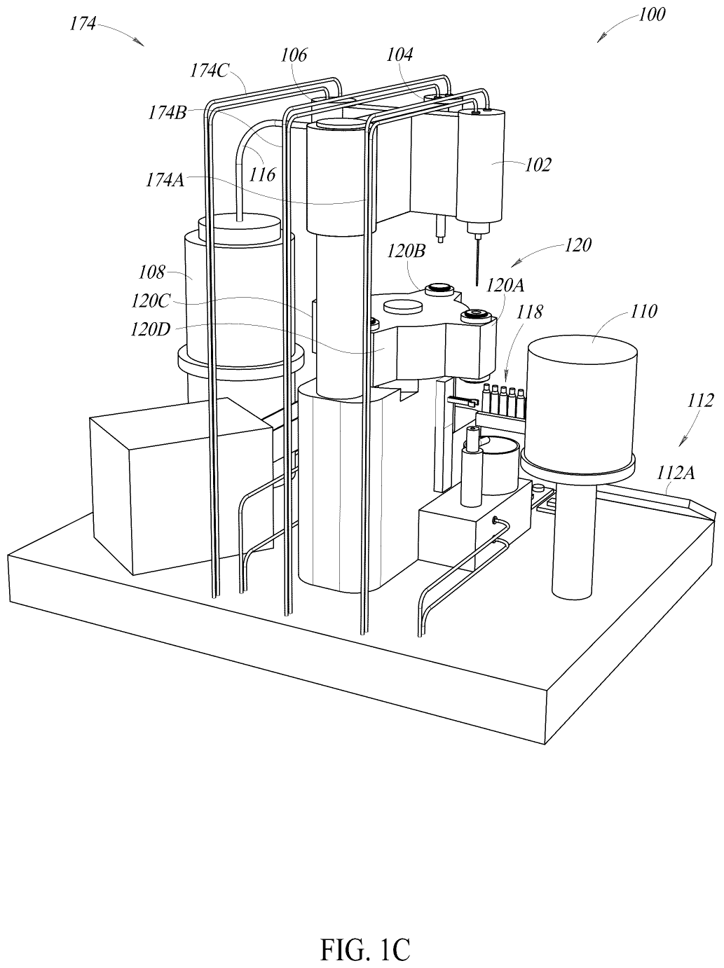

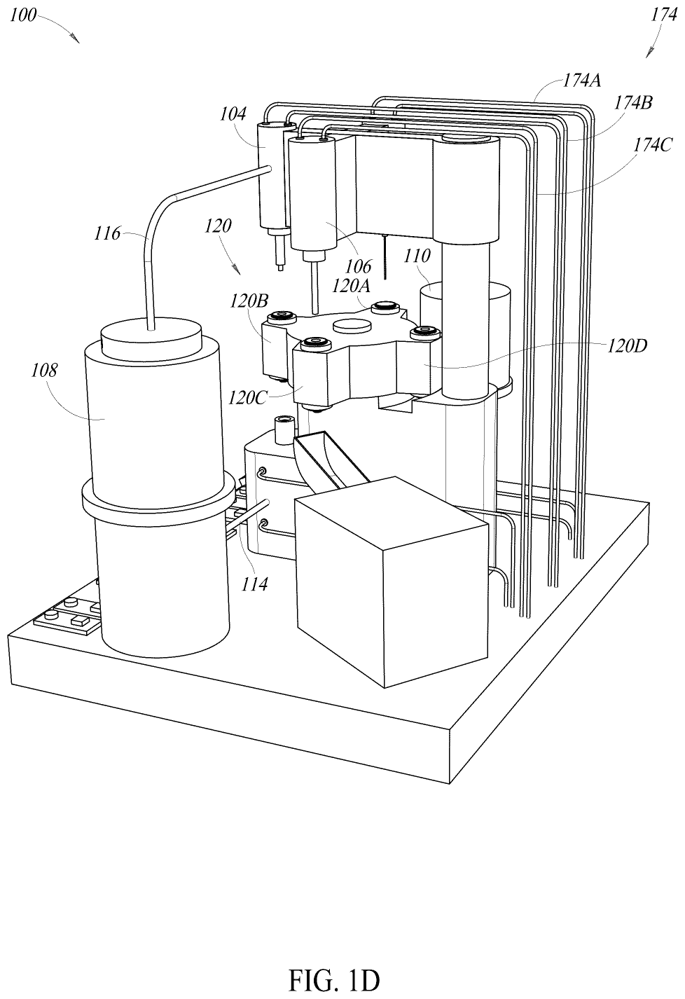

FIGS. 1A-1D illustrate a schematic diagram of a system 100 for cleaning and/or modifying a projectile casing using compressed air. In at least one embodiment, system 100 includes primer extractor 102, cleaning component 104, projectile casing extractor 106, air compressor 108, projectile casing conveyer 110, control(s) 112 (e.g., control display 112A, component control(s) 112B-J, knobs, buttons, switch, lever and/or dials), compressed air tube (e.g., pipe) 114, debris tube (e.g., pipe) 116, projectile casing 118, projectile casing rotator 120, hydraulics 174 (e.g., 174A-C), a base, and/or combinations thereof. In at least one embodiment, projectile casing rotator 120 includes one or more components which may be rotated between one or more functions or operations of a device, such as rotation component 120A at primer extractor 102, rotation component 120B at cleaning component 104, rotation component 120C at projectile casing extractor 106, and staging rotation component 120D (e.g., staging to rotate to primer extractor 102). Ordering of these components may be done clockwise, counterclockwise, lineal, and/or cyclical.

System 100 includes components 120 that can perform one or more functions, such as primer extractions, projectile casing cleaning, projectile casing extraction, primer placement, projectile casing reshaping, and/or one or more functions described herein. System 100 can include means of cleaning a projectile casing and/or performing one or more components 120 (e.g., hydraulic pump, electronic motor, stepper motor, lever, pulley, or other mechanical, electrical or hydraulic system that raises, moves, or increases a height of a base, claw, clip, engagement element, or other mechanical, electrical or hydraulic system that pulls, lifts, moves, rotates, or slides one or more projectile casings 118 and/or components). Controls may also include settings that allow for components to be performed automatically (e.g., cyclically and/or in repetition with subsequent projectile casings).

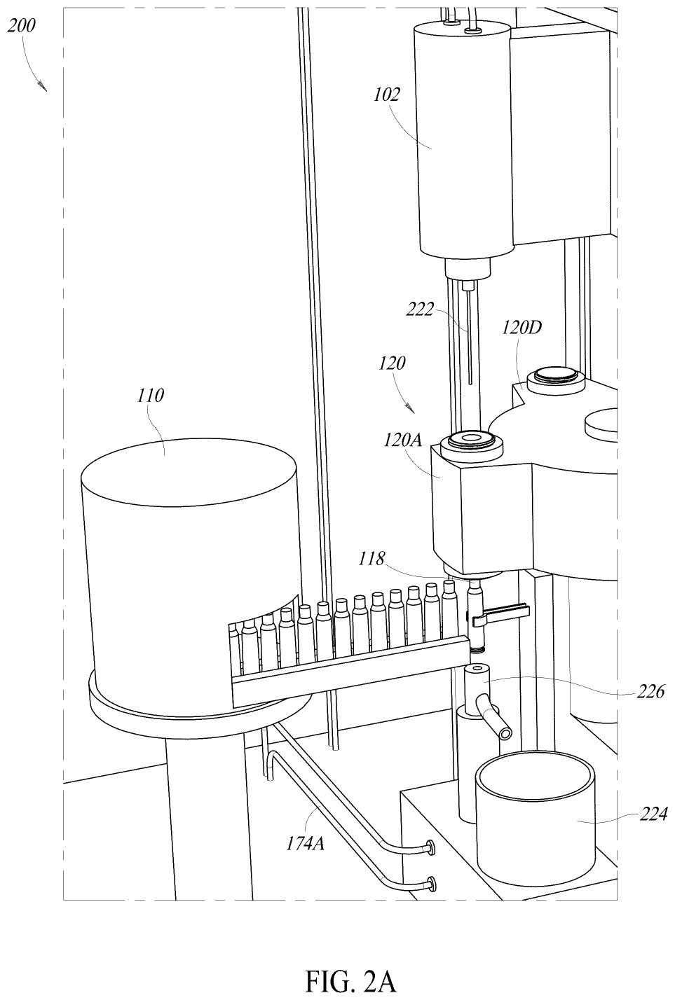

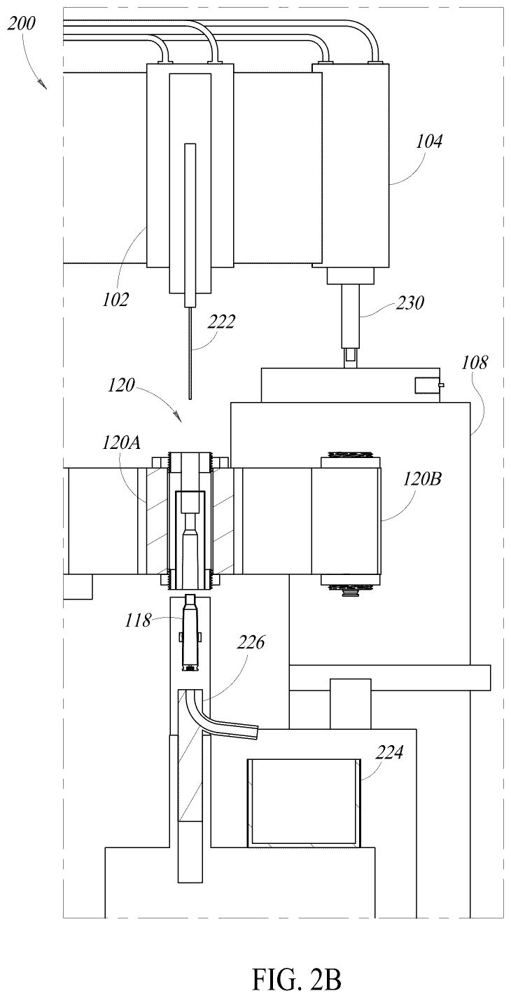

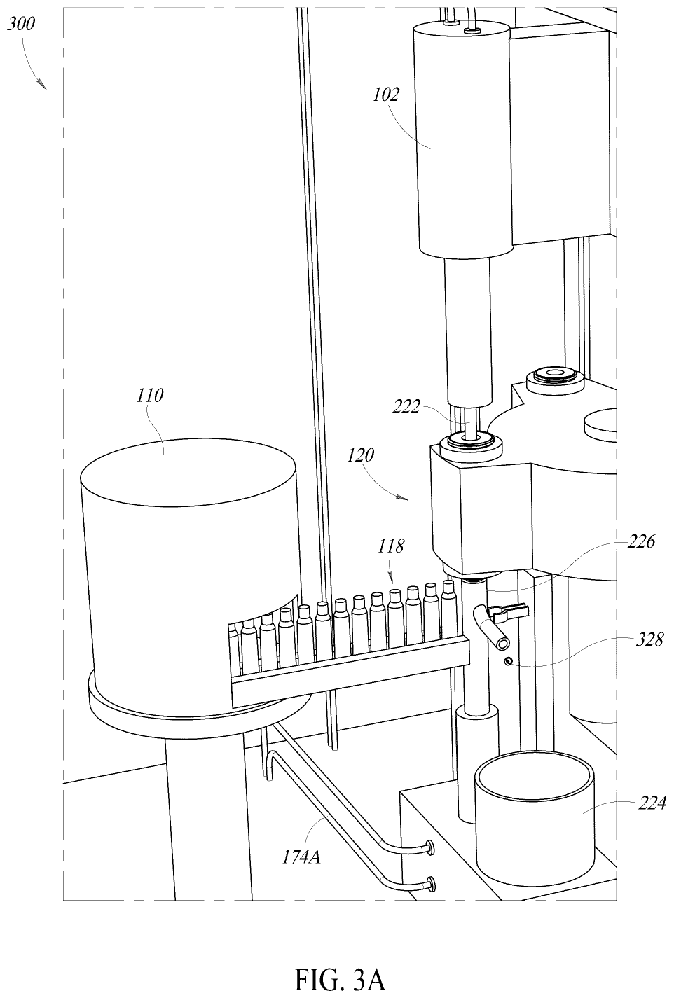

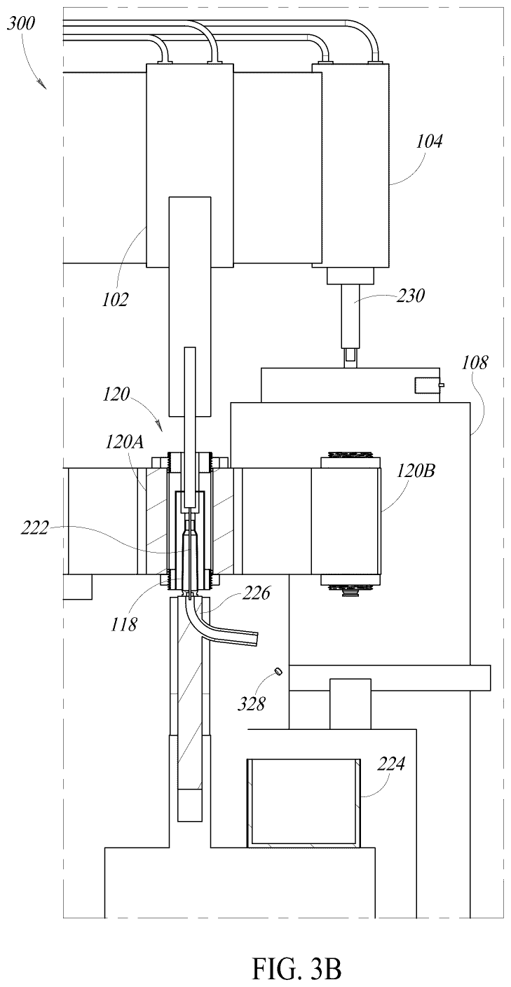

The schematic diagram in FIG. 1A includes an illustration of a front view for a projectile casing cleaning system 100. System 100 may include at least one component to extract a primer from projectile casing 118, such as primer extractor 102. Primer extractor 102 may receive one or more projectile casings, such as by one or more projectile casings 118 in a series of projectile casings along a conveyer 110. Controls 112C can move projectile casing along conveyer and/or insert projectile casing into rotation component 120A. As an example, controls 112A may rotate projectile casing rotator 120 so one or more components 120A-D are transitioned into a previous or subsequent function (e.g., primer extractor 102, cleaning component 104, projectile casing extractor 106, or staging). Projectile casings 118 to be received by system 100 may also be held in a clip and/or magazine, such that they are fed into one or more components of system 100. In at least one embodiment, primer extractor 102 receives one or more projectile casings 118 and removes (e.g., extracts) one or more primers (e.g., primer holder and/or primer cartridge) from the one or more projectile casings. As an example, primer extractor 102 may include control display 112A and/or controls 112D (e.g., moving primer extraction rod 222) to use hydraulics 174A to lower a primer extraction rod 222 (see FIGS. 2A and/or B), while projectile casing is fixed in rotation component 120A, and remove a primer. System 100 may also include an expelled primer catch 224 (see FIGS. 2A and/or B), such that expended primers fall into a container, such as to allow for primers to be removed. There may also be a method of controls to perform primer extraction (e.g., primer extractor 102) automatically, manually, or bypass primer extraction if the component is not needed (e.g., projectile casings without primers to be removed). Primer extractor 102 may otherwise include one or more systems illustrated in FIGS. 2A, 2B, 3A, and/or 3B.

The schematic diagram in FIG. 1B includes an illustration of projectile casing cleaning system 100 from a different perspective compared to FIG. 1A. System 100 uses one or more controls 112 to transition a projectile casing 118 in a rotating component 120A from primer extractor 102 to cleaning component 104. In at least one embodiment, system 100 includes one or more controls 112.

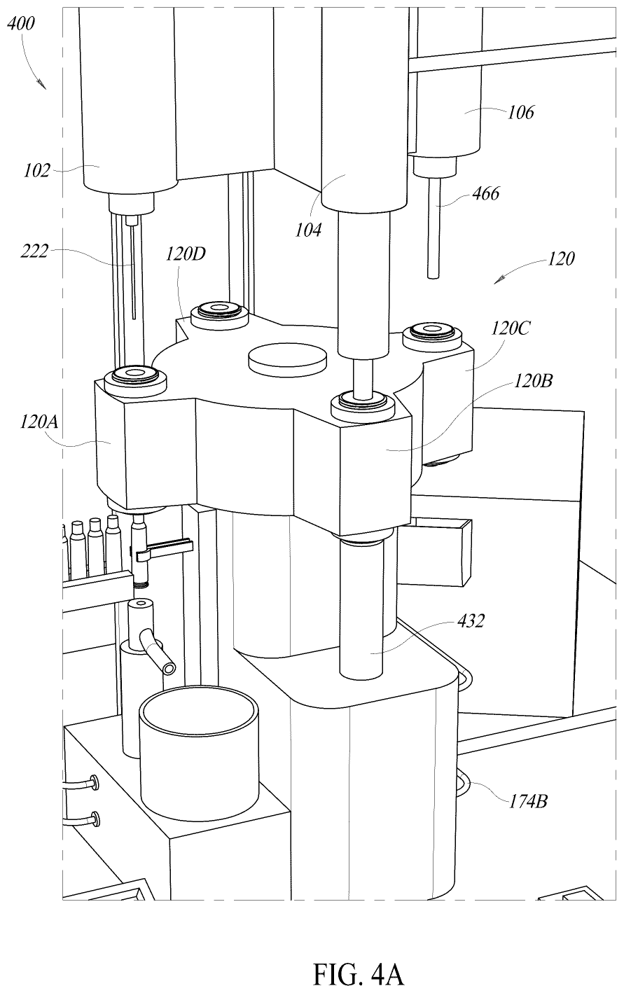

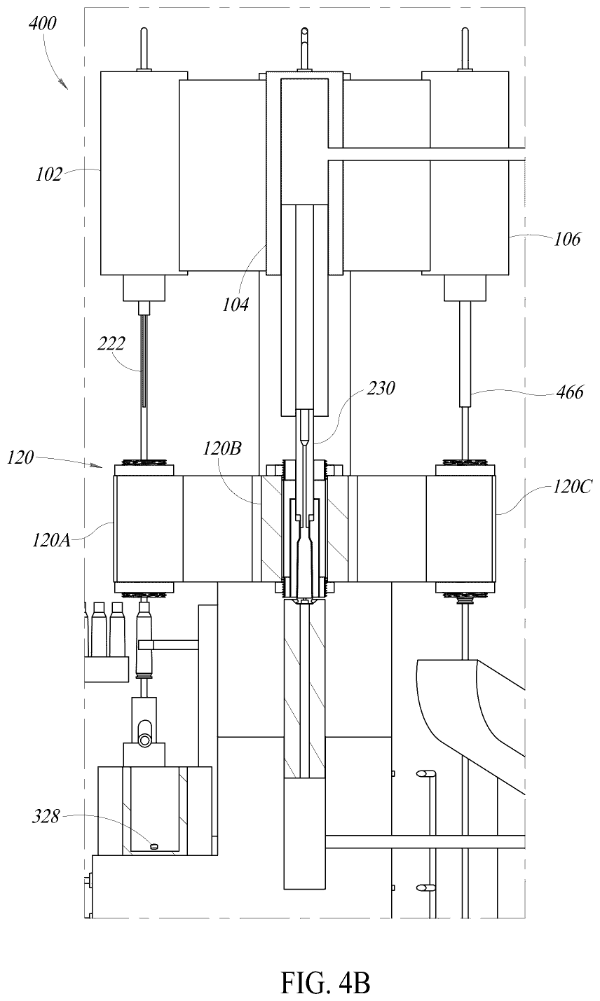

As an example, one or more controls 112 when used may perform one or more operations illustrated by controls 112A-J. Display control 112A may adjust an amount of compressed air based, at least in part, on a type of projectile casing. One or more controls 112B may position a projectile casing rotator 120, such as to position one or more projectile casings to a component performing one or more functions (e.g., primer extractor 102, cleaning component 104, projectile casing extractor 106, and/or staging). A control 112B may rotate a projectile casing rotator 120 clockwise and/or counter-clockwise. One or more controls 112C may position one or more projectile casings, such as to insert projectile casing 118 into one or more components 120A-D. One or more controls 112D may position one or more primer extraction rods 222 (see FIGS. 2A and/or B), such as to insert rod into a projectile casing to punch primer out of projectile casing 118 and/or removing primer extraction rod 222 from projectile casing 118. One or more controls 112E may position (e.g., lower and/or raise) compressed air and debris receiver 230 (see FIGS. 2A and/or B). One or more controls 112F may position (e.g., lower and/or raise) compressed air release attachment 432 (see FIG. 4). One or more controls 112G may release compressed air into projectile casing, adjust an amount of compressed air released into projectile casing (e.g., based, at least in part, on a type of projectile casing), and/or set an amount of time to release compressed air into projectile casing. In at least one embodiment, controls 112G may release compressed air from air compressor 108. One or more controls 112H may include controlling one or more settings of an air compressor, such as turning on an air compressor and/or controlling direction of air flow (e.g., compressed air enters projectile casing from bottom of projectile casing (e.g., primer pocket) or compressed air enters projectile casing from top of projectile casing). As an example, air compressor 108 generates compressed air at 40-100 psi. One or more controls 112I and J may include positioning a projectile casing extraction rod 1066, such as to extract a projectile casing or removing projectile casing extraction rod 1066 from rotation component 120C.

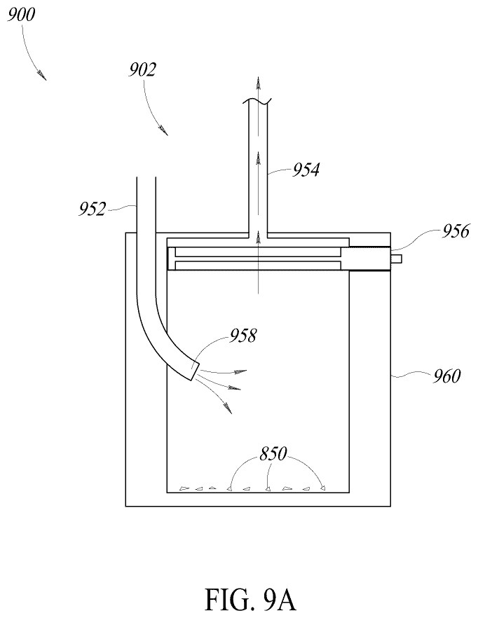

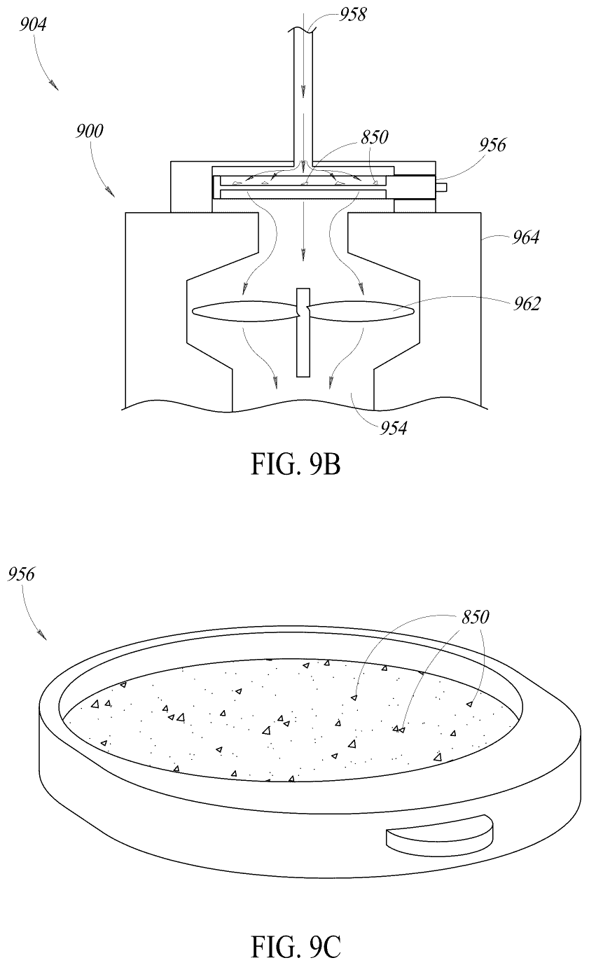

A projectile casing 118, inserted into rotation component 120A at primer extractor 102, may be transitioned to cleaning component 104. A projectile casing 118 in rotation component 120B at cleaning component may be cleaned based, at least in part, on an amount of compressed air adjusted to a type of projectile casing. As an example, air compressor 108 compresses air to a desired pressure setting and releases compressed air through compressed air tube 114 into projectile casing 118 to expel debris from projectile casing 118. As an example, a desired pressure setting is psi (e.g., 40-100 psi). Debris may exit a projectile casing 118 through debris tube 116 (e.g., pipe). As an exemplary embodiment, compressed air flow direction may also enter through bottom of a projectile casing 118 (e.g., primer pocket), debris exiting the top of a projectile casing 118. In at least one embodiment, one or more controls 112 may also include direction of air flow, such that upon cleaning filter in debris trap of air filter, compressed air may then enter through bottom of projectile casing and exit top. In at least one embodiment, air compressor 108 includes one or more filters 956 (see FIG. 9C). Air compressor 108 can also include one or more vacuum and/or debris catch components, such as vacuum source 690, filter 956, debris catch 902, and/or debris catch 904. Cleaning component 104 can also include one or more systems illustrated in FIGS. 4A, 4B, 5, 6A, 6B, 8A-8C, 12A, 12B, and/or 12C.

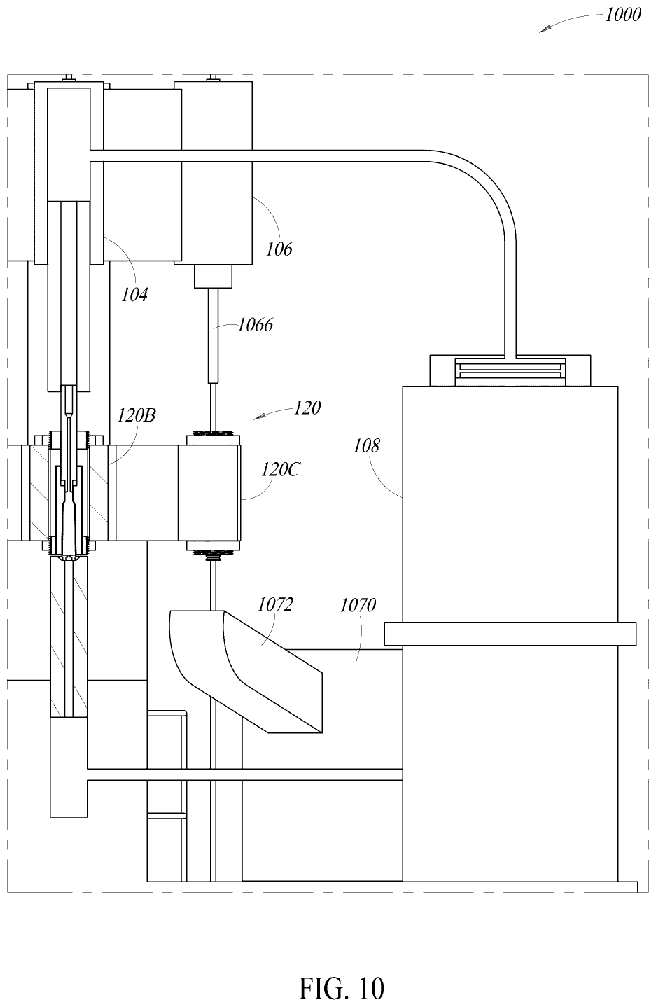

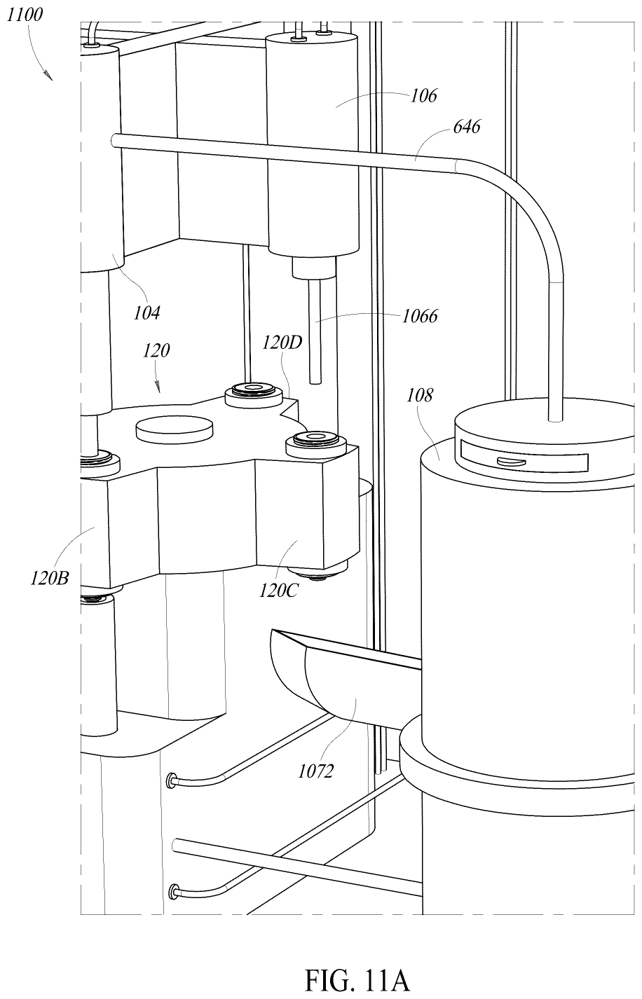

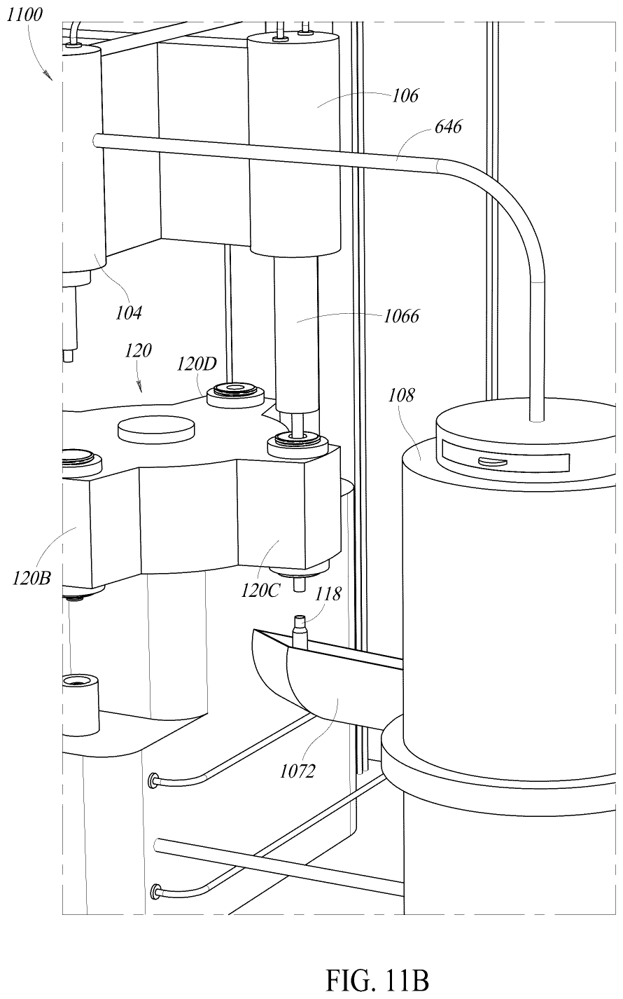

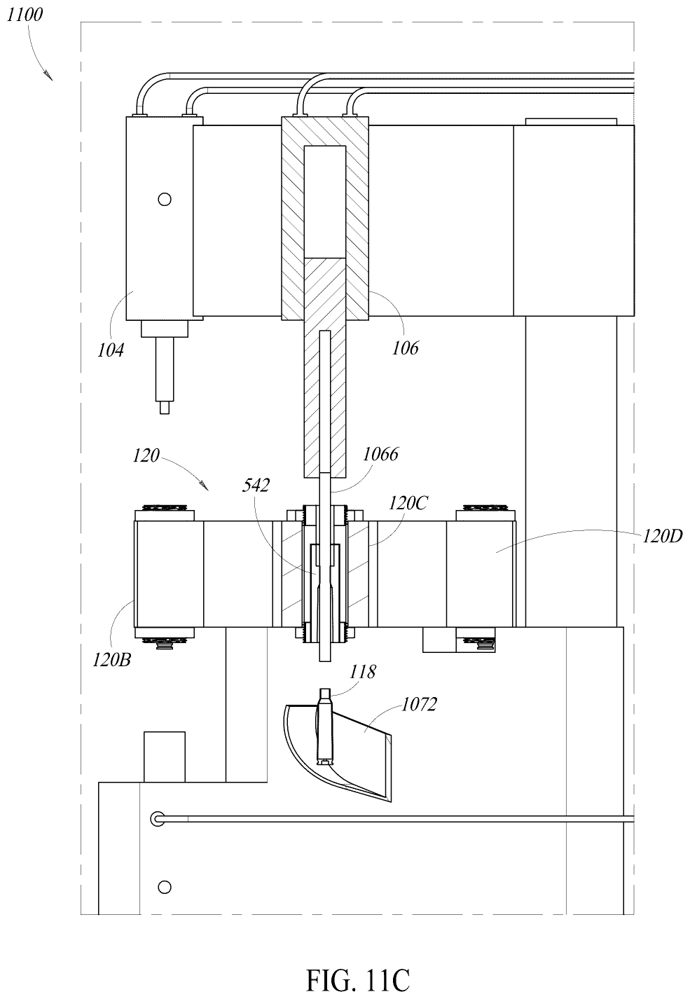

The schematic diagram in FIG. 1C includes an illustration of a projectile casing cleaning system 100 from a different perspective compared to FIGS. 1A and 1B. System 100 can use one or more controls 112 to transition a projectile casing 118 in a rotating component 120B from cleaning component 104 to the projectile casing extractor 106. In at least one embodiment, projectile casing extractor 106 includes projectile casing extractor rod 466 (see FIG. 4), a chute to catch one or more expelled projectile casings, and/or one or more expelled projectile casing bins. Projectile casing extractor 106 may otherwise include one or more systems illustrated in FIGS. 10, 11A, 11B, and/or 11C.

The schematic diagram in FIG. 1D includes an illustration of a projectile casing cleaning system 100 from a lateral perspective. In at least one embodiment, system 100 uses one or more controls 112 to transition a projectile casing 118 in a rotating component 120C from projectile casing extractor 106 to staging (e.g., position of staging rotation component 120D) and/or to return to primer extractor 102 to repeat process with a subsequent projectile casing. Hydraulics 174 may include one or more hydraulics 174A-C, such as to position, raise, lower one or more portions of one or more components performing one or more functions, such as primer extractor 102, cleaning component 104, and/or projectile casing extractor 106. In at least one embodiment, hydraulics are otherwise a hydraulic pump, electronic motor, stepper motor, lever, pulley, or other mechanical, electrical or hydraulic system that raises, moves, or increases a height of a base, claw, clip, engagement element, or other mechanical, electrical or hydraulic system that pulls, lifts, moves, rotates, or slides one or more projectile casings 118 or one or more components.

In at least one embodiment, a system, such as system 100, includes a collection of one or more hardware and/or software computing resources with instructions that, when executed, performs one or more communication processes such as those described herein. In at least one embodiment, a system, such as system 100, is a software program executing on computer hardware, application executing on computer hardware, and/or variations thereof. In at least one embodiment, one or more processes (e.g., process 1300) of system 100 are performed by any suitable processing system or unit (e.g., graphics processing unit (GPU), general-purpose GPU (GPGPU), parallel processing unit (PPU), central processing unit (CPU)), a data processing unit (DPU), such as described below, and in any suitable manner, including sequential, parallel, and/or variations thereof. In at least one embodiment, system 100 uses a machine learning training framework such as PYTORCH, TENSORFLOW, BOOST, CAFFE, MICROSOFT COGNITIVE TOOLKIT/CNTK, MXNET, CHAINER, KERAS, DEEPLEARNING4J, and/or other training framework to implement and perform operations described herein to clean a projectile casing and/or otherwise perform operations described herein.

In at least one embodiment, system 100 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 100 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

In at least one embodiment, system 100 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 100 generates an air pressure that is sufficient to remove debris from a projectile casing such that the negative impact of debris on a projectile's muzzle velocity, a projectile exist velocity, or other property of the projectile such as its smoothness is reduced (e.g., eliminated). In at least one embodiment, a system 100 uses a look-up table or a neural network trained to predict a pressure of air to use to clean a casing such that minimal damage is done to the projectile casing while optimal performance is increased. In at least one embodiment, system 100 generates air pressure that is less abrasive than a brush or other tool that can scratch or damage a projectile casing, which can generate defects that negatively impact performance of the projectile casing and/or projectile corresponding to the projectile casing.

System 100 can perform the process of cleaning projectile casings using compressed air by dynamically adjusting settings based on specific attributes of the casing to cause improved (e.g., optimal) cleaning performance for a variety of casing types and conditions. For example, system 100 can use sensors and control algorithms to assess attributes of each casing, such as material composition, caliber, degree of residue, and prior usage. Based on this assessment, system 100 modifies its settings prior to cleaning or in real-time to clean the projectile casing while reducing (e.g., minimizing) wear on the casing.

For instance, a casing made of softer material, such as brass, may require a lower pressure of compressed air to avoid deformation, whereas a steel casing may withstand higher pressures. Additionally, casings with significant fouling from previous use may require a longer exposure to the compressed air stream to fully remove residues. In contrast, casings that have been lightly used may only need a brief, high-pressure burst to achieve the desired level of cleanliness.

The direction in which the compressed air is introduced into the casing is also adjusted based on its specific geometry and fouling pattern. For example, casings with intricate internal geometries or heavy carbon deposits in certain areas may benefit from angled air streams that target these regions more effectively. By continuously adapting the cleaning parameters, including pressure, duration, and air stream direction, the system ensures that each casing is cleaned thoroughly and efficiently, regardless of its individual characteristics.

FIGS. 2A and 2B illustrate a schematic and cross-sectional view of a system 200 to remove a primer from a projectile casing, in accordance with at least one embodiment. In at least one embodiment, system 200 includes primer extractor 102, cleaning component 104, air compressor 108, projectile casing conveyer 110, projectile casing 118, projectile casing rotator 120, rotation component 120A at primer extractor, rotation component 120B at cleaning component, staging rotation component 120D, hydraulics 174A (e.g., means for controlling primer extractor), primer extraction rod 222, expelled primer catch 224, expelled primer chute 226, compressed air and debris receiver 230 and/or combinations thereof. System 200 may convey one or more projectile casings 118, place (e.g., receive) one or more projectile casings 118 in rotation component 120A, and/or extract one or more primers.

FIG. 2A illustrates a schematic view of a diagram for a system 200 to remove (e.g., extract) a primer. As an example, system 200 includes primer extractor 102, projectile casing conveyer 110, projectile casing 118, projectile casing rotator 120, rotation component 120A at primer extractor, staging rotation component 120D, hydraulics 174A (e.g., means for controlling primer extractor), primer extraction rod 222, expelled primer catch 224, expelled primer chute 226, and/or combinations thereof.

A conveyer 110 may otherwise be a series of projectile casings to be received by an automated system, a clip of projectile casing, a magazine of projectile casings, a batch of projectile casings, and/or be placed manually (e.g., singularly) into conveyer. As an example, a conveyer places projectile casings into securing arms and an expelled primer chute places (e.g., raises or lowers) a projectile casing into rotation component 120A. An expelled primer chute 226 may include a hole (e.g., cylindrical hole), which when extraction rod pushes primer outside of projectile casing, expelled primer chute 226 receives expended primer. In at least one embodiment, expelled primer chute 226 is raised and/or lowered using one or more hydraulics 174A. In at least one embodiment, an expelled primer chute 226 is fixed and system 200 includes a means for placement of a projectile casing 118.

FIG. 2B illustrates a cross-sectional view of a system 200 to remove a primer from a projectile casing. As an example, system 200 includes primer extractor 102, cleaning component 104, air compressor 108, projectile casing 118, projectile casing rotator 120, rotation component 120A at primer extractor, rotation component 120B at cleaning component, primer extraction rod 222, expelled primer catch 224, expelled primer chute 226, compressed air and debris receiver 230 and/or combinations thereof.

System 200 may receive one or more projectile casings 118, such as by moving of a base (e.g., expelled primer chute 226) towards a rotation component 120A. As an example, primer extraction chute 226 is raised using one or more hydraulics 174A, such that projectile casing 118 is placed in rotation component 120A. Rotation component 120A-D may include one or more dies and/or means for fixing a projectile casing in rotation component 120A. A die can also be referred to as a “case forming” or “resizing die.” Dies can be used to shape projectile casings (e.g., form brass cases). Dies can be used to reshape already fired projectile casings or projectile casings that are “fresh” (e.g., never been fired). Dies can also be used to confirm the shape of projectile casings used to perform precision marksmanship or fix anomalous projectile casings from a manufacturer. As an example, if a projectile casing from a manufacturer is too narrow, the projectile casing may be widened using one or more dies, progressively expanding the projectile casing by repeating a process with subsequent greater in diameter dies. Dies can be composed on multiple parts (e.g., a two piece die with multiple sets). Dies can correct, modify, or otherwise change length, size, and shaping of bullet projectile casings that have already been fired or have never been fired (e.g., produced by a manufacturer but not used yet). Dies can be composed of metal (e.g., steel), carbide, plastics, or a combination thereof.

Extraction rod 222 can be composed of metal (e.g., steel), carbide, plastics, or a combination thereof. Extraction rod 222 may be of a diameter narrower than a projectile casing neck 118 and primer hole at base of projectile casing. Extraction rod 222 may enter through neck of projectile casing until reaching primer (e.g., previously used primer), then pushing primer out of projectile casing (e.g., expelling said primer). System 200 may include a means for catching an expelled (e.g., extracted) primer 328 (see FIGS. 3A and B), such as by an expelled primer chute 226 and expelled primer catch 224. An expelled primer chute 226 need not be an enclosed cylinder, such as by using a partial cylinder with channel to receive an expelled primer 328 (see FIGS. 3A and 3B). Extraction rod 222 may then be removed from projectile casing and rotation component 120A. Rotation component 120A at primer extractor 102 may otherwise rotate into another functional component of a device, such as cleaning component 104, projectile casing extractor 106, staging, or other functional additions to the device (e.g., projectile casing shaping and/or primer seating).

In at least one embodiment, system 200 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 200 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 200 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

FIGS. 3A and 3B illustrate a schematic and cross-sectional view diagram of a system 300 removing a primer from a projectile casing, in accordance with at least one embodiment. In at least one embodiment, system 300 includes primer extractor 102, cleaning component 104, air compressor 108, projectile casing conveyer 110, projectile casing 118, projectile casing rotator 120, rotation component 120A, rotation component 120B, hydraulics 174A, primer extraction rod 222, expelled primer catch 224, expelled primer chute 226, compressed air and debris receiver 230, expelled primer 328 and/or combinations thereof. Extraction rod 222 may be inserted into projectile casing 118 inside projectile casing rotator 120, such that a primer is expelled (e.g., expelled primer 328).

FIG. 3A illustrates a schematic diagram of a system 300 removing a primer from a projectile casing. In at least one embodiment, system 300 includes primer extractor 102, projectile casing conveyer 110, projectile casing 118, projectile casing rotator 120, hydraulics 174A, primer extraction rod 222, expelled primer catch 224, expelled primer chute 226, expelled primer 328 and/or combinations thereof. Extraction rod 222 is inserted into projectile casing 118 through rotation component 120A, such that rod pushes primer out of projectile casing. Expelled primer 328 may then move on, into, and/or through an expelled primer chute 226. Expelled primer chute may be composed of metal (e.g., steel), carbide, plastics, or a combination thereof. Expelled primer 328 may then be received by an expelled primer catch 224, such as a cup, container, bin, and/or a receiving mechanism. Expelled primer catch may be composed of metal (e.g., steel), carbide, plastics, or a combination thereof.

FIG. 3B illustrates a cross-sectional view diagram of a system 300 removing a primer from a projectile casing. In at least one embodiment, system 300 includes primer extractor 102, cleaning component 104, air compressor 108, projectile casing 118, projectile casing rotator 120, rotation component 120A, rotation component 120B, primer extraction rod 222, expelled primer catch 224, expelled primer chute 226, compressed air and debris receiver 230, expelled primer 328 and/or combinations thereof.

In at least one embodiment, system 300 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 300 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 300 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

FIGS. 4A and 4B illustrate a schematic and cross-sectional view diagram of a system 400 to use compressed air to clean a projectile casing, in accordance with at least one embodiment. In at least one embodiment, system 400 includes primer extractor 102, cleaning component 104, projectile casing extractor 106, projectile casing rotator 120, rotation component 120A at primer extractor, rotation component 120B at cleaning component, rotation component 120C at projectile casing extractor, staging rotation component 120D, hydraulics 174B, primer extraction rod 222, compressed air and debris receiver 230, expelled primer 328, compressed air release attachment 432, projectile casing extractor rod 466, and/or combinations thereof.

FIG. 4A illustrates a schematic view diagram of a system 400 to use compressed air to clean a projectile casing. In at least one embodiment, system 400 includes primer extractor 102, cleaning component 104, projectile casing extractor 106, projectile casing rotator 120, rotation component 120A at primer extractor, rotation component 120B at cleaning component, rotation component 120C at projectile casing extractor, staging rotation component 120D, hydraulics 174B, primer extraction rod 222, compressed air release attachment 432, projectile casing extractor rod 466, and/or combinations thereof.

Rotation component 120B may include projectile casing 118, such as a projectile casing 118 where the primer 328 has been expelled. Rotation components 120A-D may otherwise be replaceable with different size components, such that system 400 may change a type of projectile casing to be received. Cleaning component 104 may clean a projectile casing 118 based, at least in part, on a type of projectile casing. As an example, compressed air release attachment 432 may be positioned (e.g., securely such that compressed air is oriented through the projectile casing, such as by using a rubber lining) flush to rotation component 120B. Compressed air release attachment 432 may affix to rotation component 120B and release when projectile casing is cleaned. Compressed air release attachment 432 may otherwise include material (e.g., rubber and/or plastic) to direct compressed air into projectile casing 118. In at least one embodiment, compressed air release attachment 432 directs compressed air into bottom (e.g., primer pocket) of a projectile casing 118, into the hole where no primer is present. The primer pocket may include debris (e.g., residue) from igniting the primer. As an example, compressed air cleans primer pocket, flash hole, and interior of the body of the projectile casing. Air directed through projectile casing may be according to one or more compressed air settings, such as an amount of pressure (e.g., 40-100 psi), a length of time, and/or a direction of air flow. Compressed air release attachment 432 may otherwise receive air from an air compressor 108 directed by a compressed air tube 114. Compressed air release attachment 432 is otherwise an inlet (e.g., nozzle, air inlet 538, 958, and/or 1238), which may direct compressed air into projectile casing 118. Compressed air release attachment 432 may release air into projectile casing 118, such as when invoked by one or more controls 112.

FIG. 4B illustrates a cross-sectional view diagram of a system 400 to use compressed air to clean a projectile casing. As an example, system 400 includes primer extractor 102, cleaning component 104, projectile casing extractor 106, projectile casing rotator 120, rotation component 120A at primer extractor, rotation component 120B at cleaning component, rotation component 120C at projectile casing extractor, staging rotation component 120D, hydraulics 174B, primer extraction rod 222, compressed air and debris receiver 230, expelled primer 328, compressed air release attachment 432, projectile casing extractor rod 466, and/or combinations thereof.

Compressed air may enter a projectile casing 118 using compressed air release attachment 432, such that compressed air and debris exits projectile casing into receiver 230. In at least one embodiment, receiver 230 may be a channel, cylinder, tube, or other shape to direct air exiting a projectile casing 118. Receiver 230 may otherwise include material (e.g., rubber and/or plastic) to direct compressed air out of a projectile casing 118. In at least one embodiment, receiver 230 is moved according to one or more controls, is fixed, and/or moves simultaneously to compressed air release attachment 432. Receiver 230 is otherwise an outlet (e.g., air outlet 540, 954, and/or 1240), which may direct debris and compressed air into a debris channel (e.g., debris channel 646, and/or 952). Cleaning component 104 may otherwise be one or more cleaning components and/or systems to clean a projectile casing described in FIGS. 1A-12.

In at least one embodiment, system 400 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 400 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 400 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

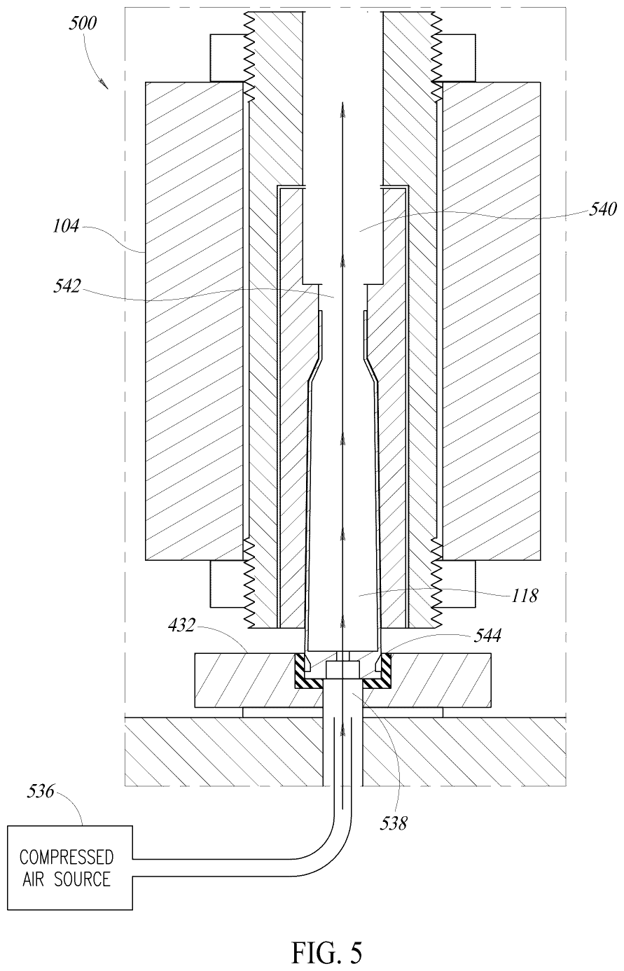

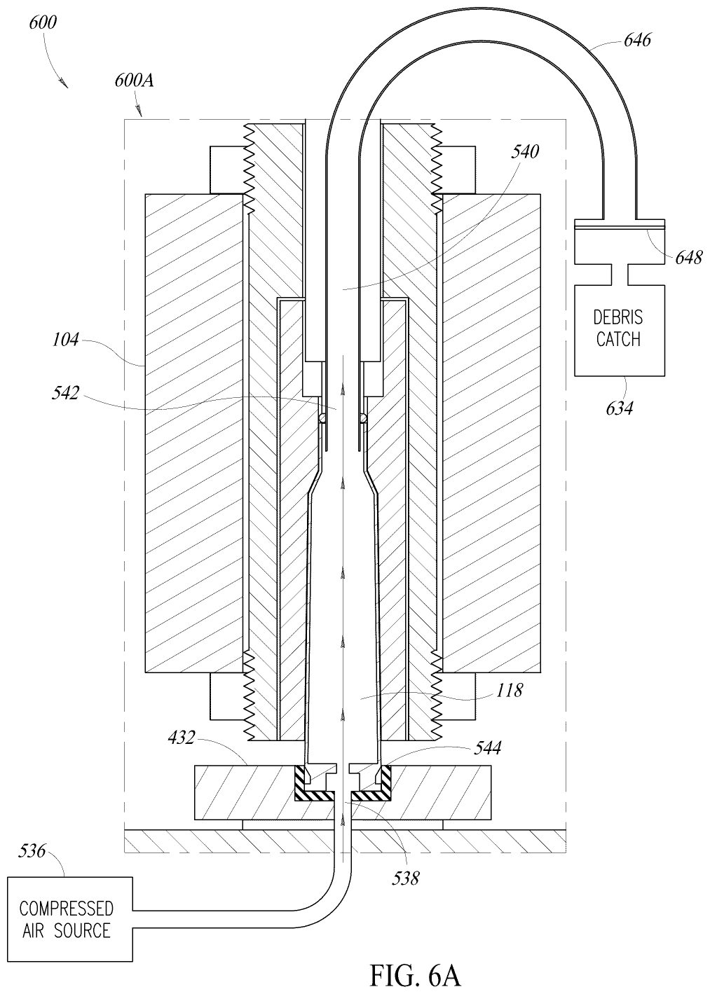

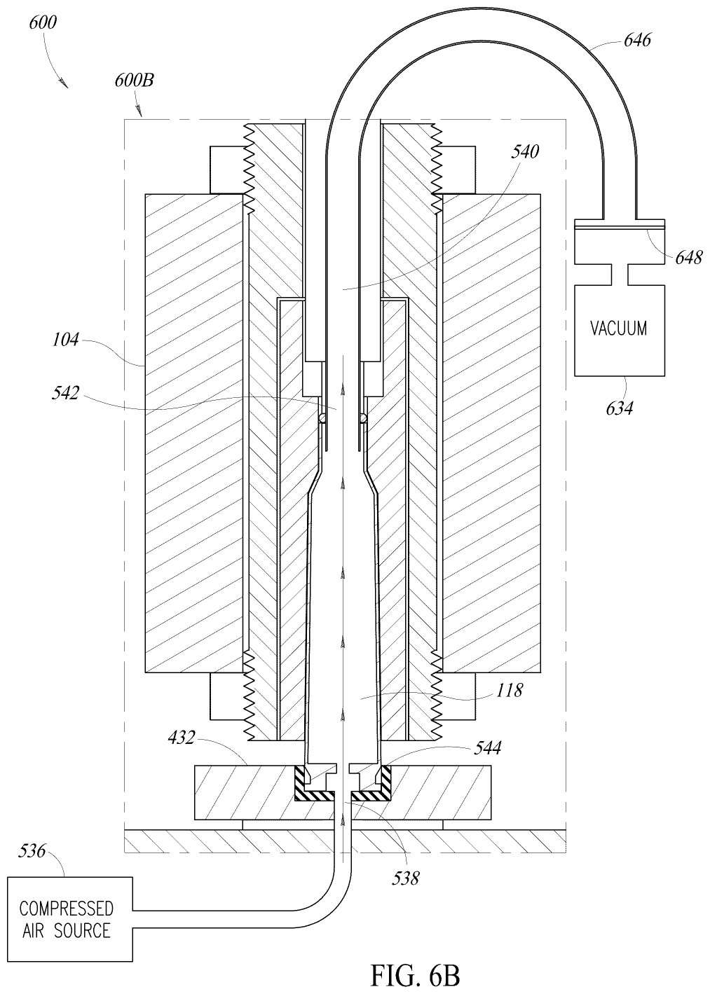

FIGS. 5, 6A, and 6B illustrate cross-sectional view diagrams of a system (e.g., system 500 and/or 600) to use compressed air to clean and/or modify a projectile casing, in accordance with at least one embodiment. In at least one embodiment, system 500 illustrates a cleaning component, with air entering from a projectile casing bottom (e.g., primer pocket) from a compressed air source 536. In at least one embodiment, system 600 illustrates a cleaning component with debris exiting into a debris catch 634. In at least one embodiment, system 600A is an example of a system using a debris catch, such as system 900 (e.g., debris catch 902 and/or 904, see FIG. 9). In at least one embodiment, system 600B is an example of a system using a debris catch which is a vacuum, such as debris catch 904 (see FIG. 9).

FIG. 5 illustrates a cross-sectional view diagram of a system 500 to use compressed air to clean and/or modify a projectile casing 118. As an example, system 500 includes a cleaning component 104 with a compressed air release attachment 432, compressed air source 536, air inlet 538, air outlet 540, projectile casing recess 542, securing material 544, and/or combinations thereof. In at least one embodiment, system 500 is part of a manual (e.g., lever) system to use compressed air to clean a projectile casing, such as by raising and lowering projectile casing into cleaning component 104, and/or an automized system to clean a projectile casing, such as in system 100.

A compressed air release attachment 432 may be a body of material that attaches to a projectile casing 118 to expel previously compressed air. A compressed air release attachment 432 may attach to a bottom of a projectile casing 118, such as by using securing material 544 to secure to the rim (e.g., extraction groove). Compressed air release attachment 432 may include an air inlet 538 and/or securing material 544. In at least one embodiment, securing material 544 includes grooves, attaching arms, securing plastic, and/or rubber. As an example, system 500 includes securing material that is rubber that is raised over projectile casing and prevents air from a compressed air source from escaping air inlet 538. In at least one embodiment, securing material 544 attaches projectile casing to compressed air release attachment 432, preventing gaps between securing material 544 and air release attachment 432, so air is directed into a bottom (e.g., primer pocket) of a projectile casing. As an example, if system 100 includes system 500 (e.g., cleaning component is rotatable to different functions), securing material 544 is a rubber material securing over projectile casing bottom. As an example, if system 500 is included in a manual system (e.g., single projectile casing raised and/or lowered in compressed air release attachment), then securing material 544 includes grooves (e.g., of a metal material) and/or arms (e.g., of a metal material) fixing projectile casing to projectile casing to air release attachment 432.

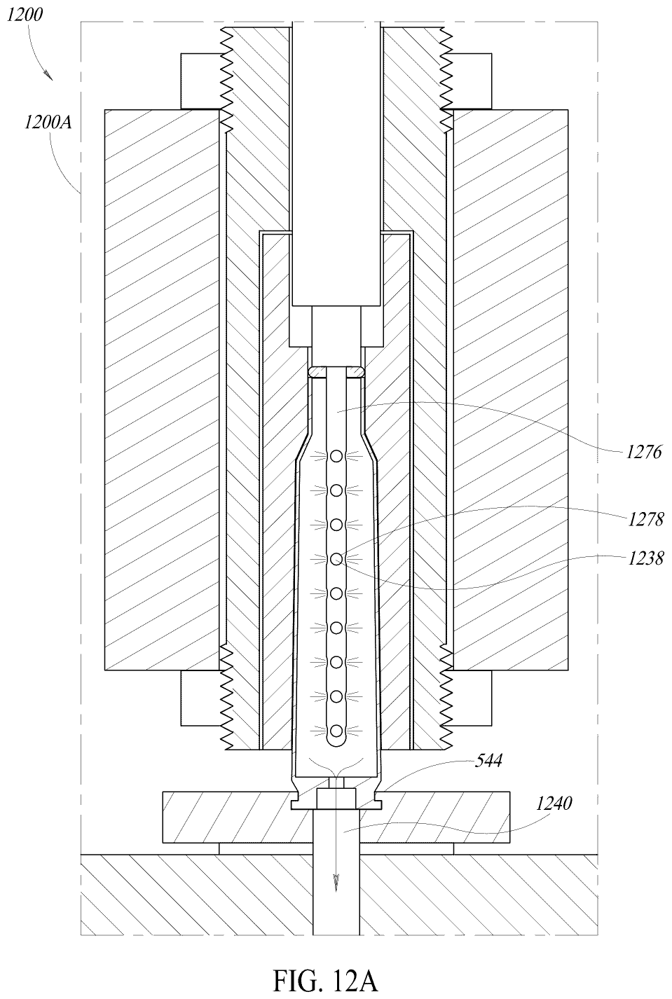

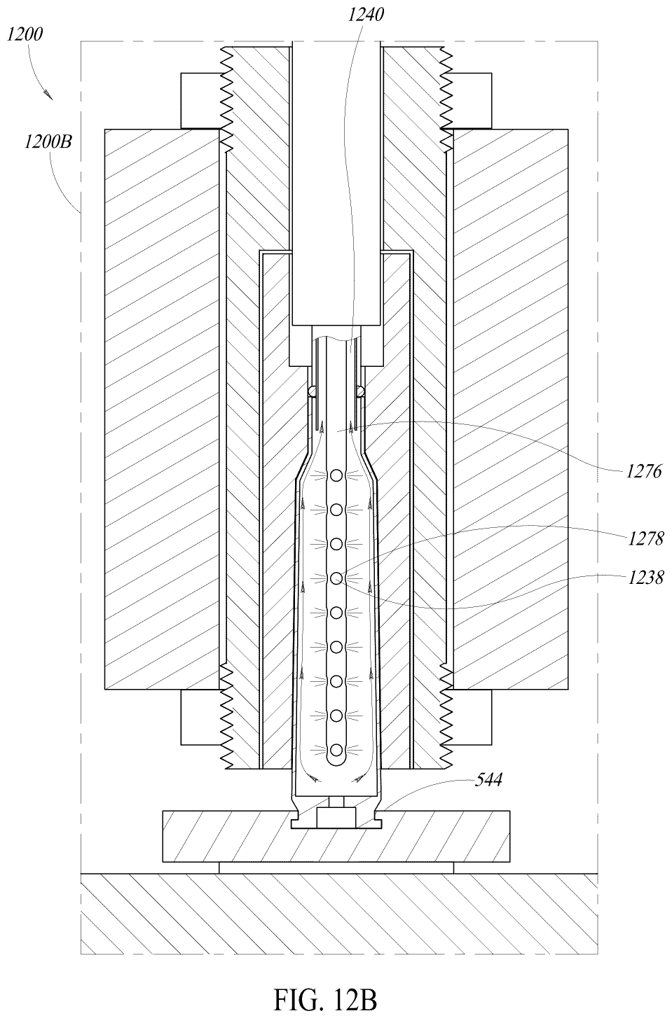

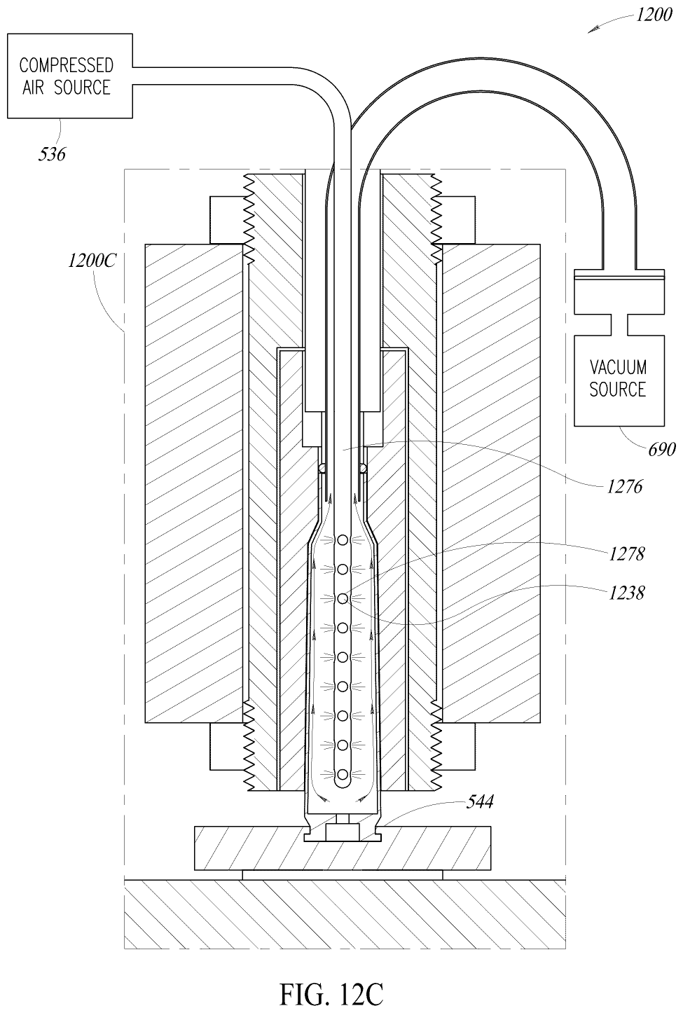

As an example, air inlet 538 may be a nozzle to expel air. An air inlet 538 may include a tube (e.g., of rubber and/or metal material) that directs air flow into a projectile casing. As an example, system 500 directs air flow into a bottom (e.g., primer pocket) of a projectile casing using air inlet 538; however, an air inlet may otherwise direct air through the top of a projectile casing, such as systems 1200A-C illustrated in FIGS. 12A-C. In at least one embodiment, a bottom of a projectile casing is located opposite an end of the projectile casing for holding the bullet. For example, a bottom of a projectile casing can be located where a primer pocket is located and where a pin would strike a primer located in the pocket. As an example, debris may be disproportionately located towards the bottom (e.g., opposite of projectile casing neck) of projectile casing and benefit from an air inlet 538 (e.g., air compression nozzle) from the bottom through the primer pocket. Debris may be disproportionately located towards bottom of projectile casing due to powder being ignited at projectile casing base, whereas bullet is seated at the top of a projectile casing. Air inlet 538 (e.g., nozzle) may be secured to compressed air source 536 and/or air release attachment. Air inlet 538 may include a combination of materials, such as being a tube directing air in air release attachment and/or a pipe attached extrinsically (e.g., outside) from an air release attachment 432 to compressed air source 536.

Air may be directed from a compressed air source 536, into an air inlet 538, and then into projectile casing 118 secured via a projectile casing recess 542 of a cleaning component 104. As an example, a projectile casing 118 is inserted into a projectile casing recess 542 via a platform (e.g., air release attachment 432) inserting projectile casing into recess 542. Projectile casing recess 542 may be included in a larger attachment that is interchangeable with other attachments for projectile casing of different sizes (e.g., caliber). As an example, projectile casing recess 542 is designed to receive a projectile casing of .308 caliber, but the attachment including projectile casing recess 542 may be replaced with an attachment with a projectile casing recess of .556 caliber. As an example, projectile casing recess 542 may be formed by one or more dies, such as those previously used to form a projectile casing to a desired size.

Air may be directed from a compressed air source 536, into an air inlet 538, into projectile casing 118, and out of a projectile casing via an air outlet 540. Air exiting a projectile casing 118 into an air outlet 540 may also carry debris (e.g., carbon residue and/or portions of brass).

An air outlet 540 may include a tube (e.g., of rubber and/or metal material) that directs air flow out of a projectile casing. As an example, system 500 directs air flow out of a top of a projectile casing using air outlet 540; however, an air outlet 540 may otherwise direct air out the bottom of a projectile casing 118, such as system 1200A illustrated in FIG. 12A. Air outlet 540 may be secured to cleaning component 104. Air outlet 540 may include a combination of materials, such as being a tube directing (e.g., funneling) air and/or debris out of cleaning component 104 and/or a pipe attached extrinsically (e.g., outside) from a cleaning component 104 to debris catch (e.g., debris catch 634).

In at least one embodiment, system 500 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 500 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 500 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

FIG. 6A illustrates a cross-sectional view diagram of a system 600 to use compressed air to clean and/or modify a projectile casing, in accordance with at least one embodiment. As an example, system 600 includes a cleaning component 104 with a compressed air release attachment 432, compressed air source 536, air inlet 538, air outlet 540, projectile casing recess 542, securing material 544, debris catch 634, debris channel 646, filter 648 (e.g., mesh) and/or combinations thereof. In at least one embodiment, system 600A includes system 500. In at least one embodiment, system 600A (e.g., system 500) directs (e.g., channels) air and debris into debris catch 624.

Air may be directed from a compressed air source 536, into an air inlet 538, into projectile casing 118, and out of a projectile casing 118 via an air outlet 540. Air exiting a projectile casing 118 into an air outlet 540 may also carry debris (e.g., carbon residue and/or portions of brass). Air outlet 540 may include or otherwise be attached to a debris channel 646.

A debris channel 646 may include a tube (e.g., of rubber and/or metal material) that directs air flow out of an air outlet 540. As an example, system 500 directs air flow out of an air outlet 540 using debris channel 646 and into a debris catch 634. Debris channel 646 may be secured to cleaning component 104. Debris channel 646 may include a combination of materials, such as being a tube directing (e.g., funneling) air and/or debris out of cleaning component 104 and/or a pipe attached extrinsically (e.g., outside) from a cleaning component 104 to debris catch (e.g., debris catch 634).

Debris catch 646 may include a bin, bucket, debris catching attachment, mesh 648, a vacuum (e.g., see system 600B with vacuum included in debris catch 634), a filter, and/or other material described herein to contain or otherwise catch debris. Debris catch 646 may include a mesh 648 (e.g., filter) surrounding debris channel 646 entering debris catch 634, such that air may exit but debris is trapped into the catch 634. Debris catch 646 may include system 900 and/or filter 956 (see FIGS. 9A-9C).

FIG. 6B illustrates a cross-sectional view diagram of a system 600 to use compressed air to clean and/or modify a projectile casing, in accordance with at least one embodiment. As an example, system 600 includes a cleaning component 104 with a compressed air release attachment 432, compressed air source 536, air inlet 538, air outlet 540, projectile casing recess 542, securing material 544, debris catch 634 that includes a vacuum, debris channel 646, filter 648 (e.g., mesh), and/or combinations thereof.

In at least one embodiment, debris catch 634 includes a vacuum. As an example, debris catch 634 including a vacuum is as illustrated in system 904 (see FIG. 9B), such as to recycle air to be reused by air compressor 108 (see FIG. 1). In at least one embodiment, a vacuum is an area where the pressure is lower than atmospheric pressure, which can then be used to direct air and/or debris into debris catch to balance pressure in the area with atmospheric pressure. As an example, a fan may cause air to be of a lower pressure for the air. The system can include a sealed chamber where projectile casings are placed, with the vacuum apparatus connected to create a low-pressure environment. Once the projectile casings are loaded, the vacuum reduces the chamber's pressure, allowing for a more effective blast of compressed air. When the compressed air is introduced, the low-pressure environment ensures that the air reaches all surfaces of the projectile casings, including internal areas that are typically difficult to clean. The force of the compressed air dislodges dirt, powder residue, and other contaminants from the projectile casings. After cleaning, the chamber is returned to atmospheric pressure, and the projectile casings are removed, free of debris and ready for further processing or reuse.

In at least one embodiment, system 600 includes system 600A and/or B. In at least one embodiment, system 600 includes one or more processors and/or components to load automatically, by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 600 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 600 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

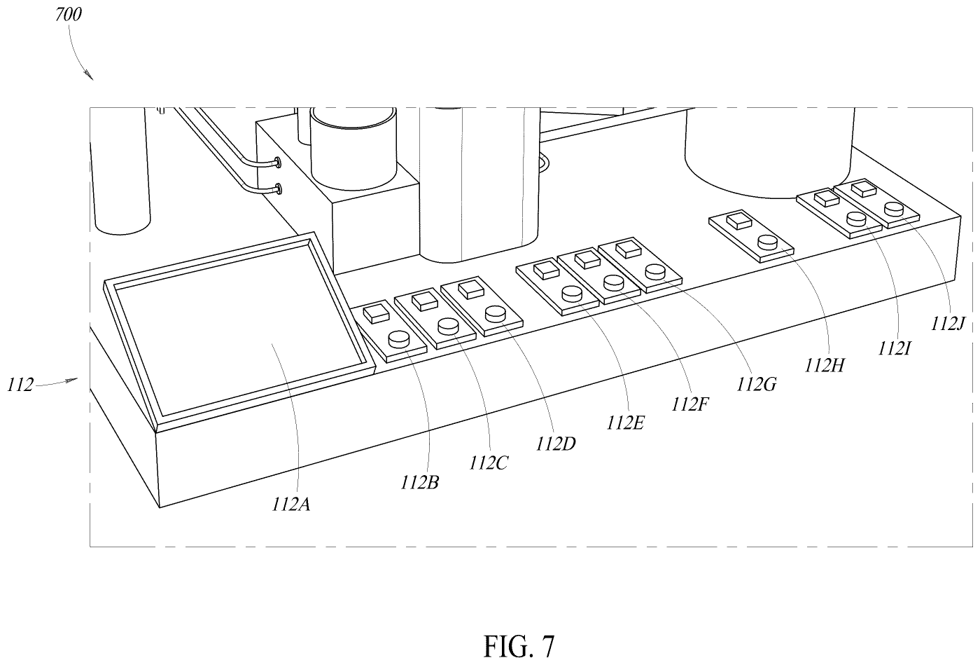

FIG. 7 illustrates a schematic diagram of a system 700 including controls to clean and/or modify a projectile casing 118, in accordance with at least one embodiment. In at least one embodiment, system 700 includes one or more display controls 112A, controls 112B-J, software programs, hydraulic controls, buttons, switches, levers, knobs, adjustments, dials, display screens, touch screens, and/or combinations thereof.

In at least one embodiment, one or more controls 112, when invoked, perform one or more processes, such as process 1300. Display control 112A may adjust an amount of compressed air based, at least in part, on a type of projectile casing. One or more controls 112B may position a projectile casing rotator 120, such as to position one or more projectile casings to a component performing one or more functions function (e.g., primer extractor 102, cleaning component 104, projectile casing extractor 106, and/or staging). A control 112B may rotate a projectile casing rotator 120 clockwise and/or counter-clockwise. One or more controls 112C may position one or more projectile casings, such as to insert projectile casing 118 into one or more components 120A-D. One or more controls 112D may position one or more primer extraction rods 222 (see FIGS. 2A and/or 2B), such as to insert rod into a projectile casing to punch primer out of projectile casing 118 and/or removing primer extraction rod 222 from projectile casing 118. One or more controls 112E may position (e.g., lower and/or raise) compressed air and debris receiver 230 (see FIGS. 2A and/or 2B). One or more controls 112F may position (e.g., lower and/or raise) compressed air release attachment 432 (see FIG. 4). One or more controls 112G may release compressed air into projectile casing, adjust an amount of compressed air released into projectile casing (e.g., based, at least in part, on a type of projectile casing), and/or set an amount of time to release compressed air into projectile casing. In at least one embodiment, controls 112G may release compressed air from air compressor 108. One or more controls 112H may include controlling one or more settings of an air compressor, such as turning on an air compressor and/or controlling direction of air flow (e.g., compressed air enters projectile casing from bottom of projectile casing or compressed air enters projectile casing from top of projectile casing). One or more controls 112I and J may include positioning a projectile casing extraction rod 1066, such as to extract a projectile casing or removing projectile casing extraction rod 1066 from rotation component 120C.

In at least one embodiment, a system, such as system 700, includes a collection of one or more hardware and/or software computing resources with instructions that, when executed, performs one or more communication processes such as those described herein. In at least one embodiment, a system, such as system 700, is a software program executing on computer hardware, application executing on computer hardware, and/or variations thereof. In at least one embodiment, one or more processes (e.g., process 1300) of system 700 are performed by any suitable processing system or unit (e.g., graphics processing unit (GPU), general-purpose GPU (GPGPU), parallel processing unit (PPU), central processing unit (CPU)), a data processing unit (DPU), such as described below, and in any suitable manner, including sequential, parallel, and/or variations thereof. In at least one embodiment, system 100 uses a machine learning training framework such as PYTORCH, TENSORFLOW, BOOST, CAFFE, MICROSOFT COGNITIVE TOOLKIT/CNTK, MXNET, CHAINER, KERAS, DEEPLEARNING4J, and/or other training framework to implement and perform operations described herein to use air compression to clean a projectile casing based, at least in part, on a type of projectile casing and/or otherwise perform operations described herein.

System 700 may include a neural network to determine an air setting (e.g., psi, direction, and/or other setting described herein) and/or generate instructions to use an air setting to clean a projectile casing. As an example, a neural network may generate one or more images, diagrams, models, and/or maps (e.g., velocity and/or pressure maps) to illustrate and/or predict air flow directed into a projectile casing. As an example, a neural network may use one or more images, diagrams, models, and/or maps (e.g., velocity and/or pressure maps) to model debris and air flow out of a projectile casing.

In at least one embodiment, system 700 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 700 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 700 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

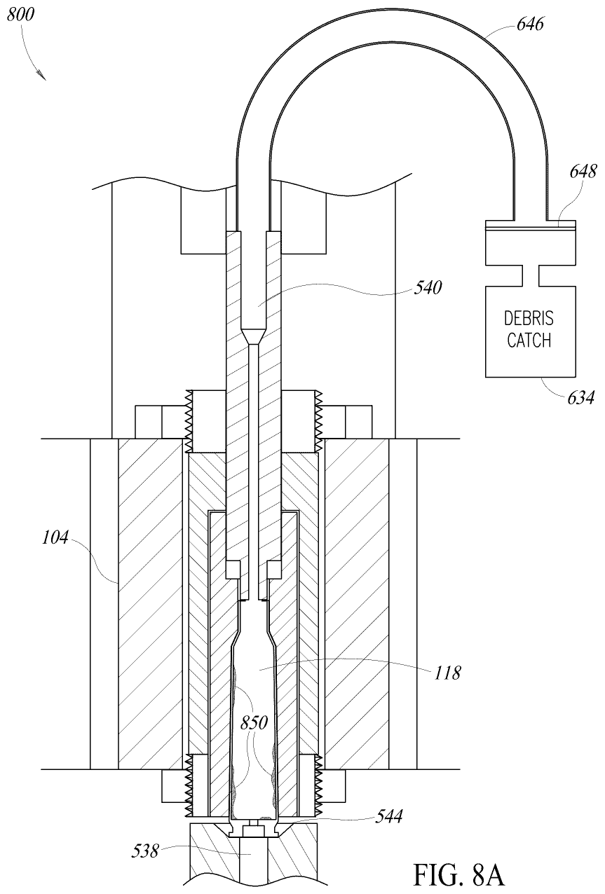

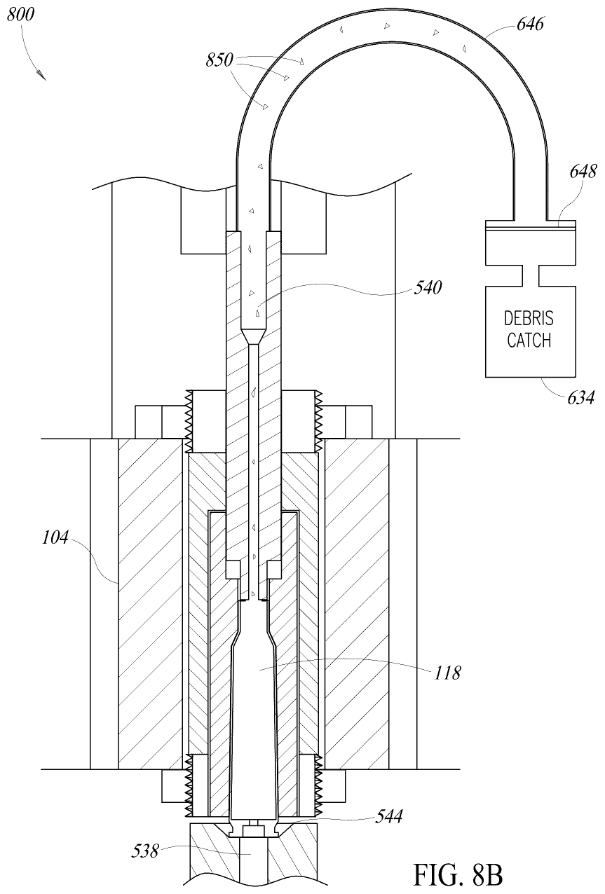

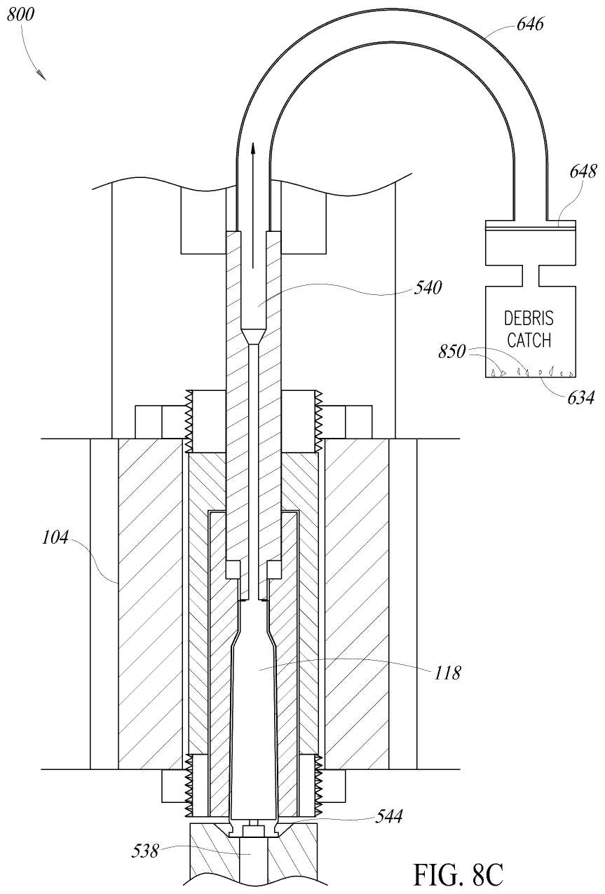

FIGS. 8A-8C illustrate cross-sectional view diagrams of a system 800 to use compressed air to clean carbon from a projectile casing, in accordance with at least one embodiment. In at least one embodiment, system 800 includes cleaning component 104, projectile casing 118, air inlet 538, air outlet 540, securing material 544, debris catch 634, debris channel 646, mesh 648 (e.g., filter), carbon debris 850, and/or combinations thereof.

FIG. 8A illustrates a cross-sectional view diagram of a system 800 to use compressed air to clean carbon from a projectile casing 118. As an example, carbon debris 850 is present on the interior of a body of a projectile casing. Carbon debris 850 may also include brass (e.g., brass shavings). Projectile casing may also include debris located in primer pocket (e.g., space in projectile casing to receive a primer). As an example, projectile casing 118 is attached to an air inlet (e.g., nozzle) via a securing material, such as rubber grooves, to receive and attach a projectile casing to a base.

FIG. 8B illustrates a cross-sectional view diagram of system 800 with compressed air released into a projectile casing 118. As an example, compressed air enters projectile casing 118 via air inlet 538, which may first enter a projectile casing through a primer pocket. Compressed air then carries (e.g., moves) debris into air outlet 540 at a top (e.g., out the neck) of a projectile casing 118. Carbon debris 850 may include brass pieces as well. Projectile casing 118 may be cleaned of carbon debris 850. As an example, unwanted carbon debris exits projectile casing into air and debris outlet 540, such that projectile casing now is cleaned and/or includes wanted carbon residue (e.g., carbon residue to smooth, or otherwise mask projectile casing brass irregularities). Carbon residue 850 enters air outlet 540 and debris channel 646.

FIG. 8C illustrates a cross-sectional view diagram of system 800 with carbon residue 850 captured in debris catch 634. As an example, the now released compressed air continues to flow through projectile casing 118, into air outlet 540 and debris channel 646, and channel's debris into debris catch 634. Debris catch 634 may include mesh 648 that surrounds debris channel 646 to allow air to exit a debris catch while retaining debris. Debris catch 634 may include means of detaching debris catch 634 from system 800, such as to dispose of carbon debris 850 and/or clean debris catch 634. Air may exit through mesh 648 while debris 850 is retained in debris catch 634. Mesh 648 may include one or more interconnected materials (e.g., metal, plastic, fibers, and/or flexible material), such as to act as a screen and/or filter to retain (e.g., capture) debris 850. Projectile casing 118 is cleaned to a desired amount of carbon residue based, at least in part, on a type of projectile casing.

In at least one embodiment, system 800 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 800 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 800 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

FIG. 9A illustrates a cross-sectional view diagram of a debris trap 902 (e.g., debris trap 902), in accordance with at least one embodiment. In at least one embodiment, system 900 includes debris trap 902. As an example, debris trap 902 may include debris channel 952, air outlet 954, filter 956 (e.g., mesh), air and debris inlet 958, debris catch 960, and/or combinations thereof.

Air and Debris 850 may enter a debris trap 902 using a debris channel 952. Debris collects in a bin 960. A bin 960 may be fixed to a projectile casing cleaning device. A bin 960 may also be attachable to a projectile casing cleaning device, such as to be able to remove debris from debris trap. In at least one embodiment, the bottom of a bin 960 may also be hinged and/or removable to clean debris from bottom. Debris catch 902 may also include a mesh and/or filter 956 to allow air to be released from the catch 902 while still retaining the debris 850. Air may pass through the filter 956 and into the air outlet 954. In at least one embodiment, filter 956 is otherwise mesh 648.

FIG. 9B illustrates a cross-sectional view diagram of a debris trap 904 (e.g., debris trap 904), in accordance with at least one embodiment. In at least one embodiment, system 900 includes debris trap 904 (e.g., vacuum 964). As an example, debris trap 904 may include debris 850, air outlet 954, filter 956 (e.g., mesh), air and debris inlet 958, fan 962, vacuum 964, and/or combinations thereof.

A debris trap 904 includes one or more vacuums, such as vacuum 964. As an example, air and debris enter debris trap 904 by air and debris inlet 958. A filter 956 is a mesh capable of allowing air to pass through and catch debris 850 from a projectile casing 118. Air may move due to a vacuum 964 in debris catch 904, such as by using a fan 962 to displace air, causing an imbalance of pressure to move in the direction of the fan, such as towards air outlet 954. Air outlet 954 may further be used as an intake to an air compressor 108 or otherwise be a component thereof.

In at least one embodiment, system 900 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 900 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 900 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

FIG. 9C illustrates a schematic diagram of a filter 956 trapping debris 850, in accordance with at least one embodiment. Filter 956 may include one or more interconnected materials (e.g., metal, plastic, fibers, and/or flexible material), such as to act as a screen and/or filter to retain (e.g., capture) debris 850. Filter 956 may include a grip, such that it may be removed from a debris catch 900, placed into debris catch 900, and/or cleaned of debris 850.

FIG. 10 illustrates a cross-sectional and schematic view of a system 1000 for cleaning a projectile casing with compressed air, in accordance with at least one embodiment. In at least one embodiment, system 1000 includes cleaning component 104, projectile casing extractor 106, air compressor 108, projectile casing rotator 120, rotation component 120B at cleaning component, rotation component 120C at projectile casing extractor, projectile casing extraction rod 1066, projectile casing bin 1070, projectile casing chute 1072, and/or combinations thereof.

In at least one embodiment, upon performing projectile casing 118 cleaning at cleaning component 104, a projectile casing rotator 120 rotates projectile casing 118 into position at projectile casing extractor 106, such as rotation component 120C at projectile casing extractor. As an example, projectile casing rotator 120 may rotate one or more components 120A-D to projectile casing extractor 106. To extract a projectile casing 118 (e.g., expel projectile casing) at projectile casing extractor 106, projectile casing extractor 106 includes a projectile casing extraction rod 1066 to push a projectile casing out of rotation component 120C.

Casing extraction rod 1066 may be composed of metal, plastic, and/or one or more materials described herein. As an example, projectile casing extraction rod 1066 is of a diameter wider than a hole to receive a primer (e.g., to prevent rod from passing through primer hole), but a diameter narrower than the neck of the projectile casing. As another example, a length of a projectile casing extraction rod 1066 is a length to both enter a projectile casing and push it by its base outside a rotation component 120C. A projectile casing 118 may be pushed out of rotation component 120C and caught by a projectile casing chute 1072. Projectile casing chute 1072 may direct (e.g., via gravity) projectile casing 11 into a projectile casing bin 1070 (e.g., projectile casing catch).

In at least one embodiment, system 1000 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 1000 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 1000 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

FIGS. 11A-11C illustrate schematic diagrams and a cross-sectional view of a system 1100 to remove a cleaned and/or modified projectile casing, in accordance with at least one embodiment. In at least one embodiment, system 1100 includes cleaning component 104, projectile casing extractor 106, air compressor 108, debris channel 646, projectile casing rotator 120, rotation component 120B-D, projectile casing extraction rod 1066, projectile casing chute 1072, and/or combinations thereof.

FIG. 11A illustrates a schematic diagram view of a system to remove a cleaned and/or modified projectile casing. As an example, system 1100 includes cleaning component 104, projectile casing extractor 106, air compressor 108, debris channel 646, projectile casing rotator 120, rotation component 120B-D, projectile casing extraction rod 1066, projectile casing chute 1072, and/or combinations thereof. In at least one embodiment, projectile casing 118 is in rotation component 120C with projectile casing extraction rod 1066 in line with neck of projectile casing, such as to enable projectile casing rod to enter centered through projectile casing 118. Furthermore, a projectile casing chute 1072 may be below rotation component 120C to receive an expelled projectile casing.

FIG. 11B illustrates a schematic diagram view of a system 1100 to remove a cleaned and/or modified projectile casing. As an example, system 1100 includes cleaning component 104, projectile casing extractor 106, air compressor 108, projectile casing 118, debris channel 646, projectile casing rotator 120, rotation component 120B-D, projectile casing extraction rod 1066, projectile casing chute 1072, and/or combinations thereof. In at least one embodiment, projectile casing 118 is expelled from rotation component 120C with projectile casing extraction rod 1066 having entered both projectile casing 118 and rotation component 120C, pushing projectile casing from component 120C. Furthermore, a projectile casing chute 1072 may receive projectile casing 118 to directed projectile casing to a bin 1070.

FIG. 11C illustrates a cross-sectional diagram view of a system 1100 to remove a cleaned and/or modified projectile casing. As an example, system 1100 includes cleaning component 104, projectile casing extractor 106, air compressor 108, projectile casing 118, projectile casing recess 542, debris channel 646, projectile casing rotator 120, rotation component 120B-D, projectile casing extraction rod 1066, projectile casing chute 1072, and/or combinations thereof. In at least one embodiment, projectile casing 118 is expelled from rotation component 120C with projectile casing extraction rod 1066 having entered both projectile casing 118 and projectile casing recess 542 of rotation component 120C, pushing projectile casing from component 120C. Furthermore, a projectile casing chute 1072 may receive projectile casing 118 to directed projectile casing to a bin 1070.

In at least one embodiment, system 1100 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 1100 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 1100 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

FIGS. 12A-12C illustrate cross-sectional views of system 1200 to clean a projectile casing using a rod, in accordance with at least one embodiment. In at least one embodiment, cleaning component system 1200 includes one or more cleaning component systems illustrates 1200A-C, see FIGS. 12A-C.

FIG. 12A illustrates a cross-sectional view of system 1200A to clean a projectile casing using a rod 1276. In at least one embodiment, system 1200A includes air inlet 1238, air outlet 1240, rod 1276, one or more holes 1278, securing material 544, and/or combinations thereof. As an example, an air inlet 1238 from rod 1276 expels compressed air into a projectile casing. Debris from a projectile casing may then exit via the primer hole at the projectile casing bottom. As an example, a rod 1276 may include one or more holes 1278 to direct compressed air into a projectile casing, causing air to enter at a desired direction and/or pressure from rod 1276.

FIG. 12B illustrates a cross-sectional view of system 1200A to clean a projectile casing using a rod 1276. In at least one embodiment, system 1200B includes air inlet 1238, air outlet 1240, rod 1276, one or more holes 1278, securing material 544, and/or combinations thereof. As an example, an air inlet 1238 from rod 1276 expels compressed air into a projectile casing. Debris from a projectile casing may then exit via an air outlet 1240 at top of the projectile casing. As an example, a rod 1276 may include one or more holes 1278 to direct compressed air into a projectile casing, causing air to enter at a desired direction and/or pressure from rod 1276. Securing material 544 of a base may attach to projectile casing, such as attaching with a desired pressure to prevent air from escaping from projectile casing bottom, directing air towards air outlet 1240.

FIG. 12C illustrates a cross-sectional view of system 1200A to clean a projectile casing using a rod 1276. In at least one embodiment, system 1200C includes compressed air source 536, vacuum 690, air inlet 1238, air outlet 1240, rod 1276, one or more holes 1278, securing material 544, and/or combinations thereof. As an example, an air inlet 1238 to a projectile casing expels compressed air from compressed air source 536. Air inlet 1238 from rod 1276 may expel compressed air into a projectile casing. Debris from a projectile casing may then exit via an air outlet 1240 at top of the projectile casing. As an example, a rod 1276 may include one or more holes 1278 to direct compressed air into a projectile casing, causing air to enter at a desired direction and/or pressure from rod 1276. Securing material 544 of a base may attach to projectile casing, such as attaching with a desired pressure to prevent air from escaping from projectile casing bottom, directing air towards air outlet 1240. A vacuum 690 attached to air outlet 1240 may cause debris to leave projectile casing and enter a debris catch.

In at least one embodiment, system 1200 includes one or more processors and/or components to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 1200 is, is included in, and/or otherwise includes systems illustrated in FIGS. 1A-12C to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein. In at least one embodiment, system 1200 performs one or more processes illustrated in FIGS. 1A-13, such as process 1300 to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings; and/or otherwise perform operations described herein.

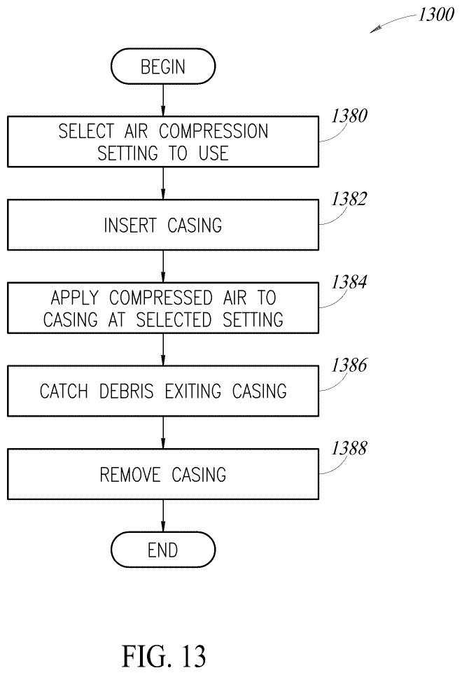

FIG. 13 is a process 1300 flow diagram for cleaning and/or modifying a projectile casing using compressed air. In at least one embodiment, a processor, programmer, system 100 (from FIG. 1), or a marksman performs process 1300 that includes one or more steps to select 1380 air compression setting to use with a type of projectile casing, insert 1382 projectile casing, release 1384 compressed air into projectile casing at selected settings, catch 1386 debris exiting projectile casing, remove 1388 projectile casing, perform operations described herein, and/or combinations thereof.

At selection step 1380, a programmer, system 100, or expert shooter may select a setting to use with a type of projectile casing. For example, an expert shooter can enter details of a projectile casing into a database or NN and a response can include how much air pressure to use to clean it. An expert shooter may enter details into one or more control panels, such as control 112A. To select 1380 as a setting, one or more controls (e.g., controls 112) may receive an indication, such as an indication of a type of projectile casing, an amount of debris (e.g., low, medium, high) in projectile casing, a desired amount of debris to retain in projectile casing (e.g., none, minimal, low, medium, and/or high), thickness of projectile casing, shape of projectile casing, an amount of previous cleaning (e.g., first time cleaning, second time cleaning, combination of methods and/or repetitions of compressed air), how many times projectile casing was previously used to fire a projectile, and/or other considerations described herein. As an example, a system (e.g., systems illustrated in FIGS. 1A-12C) may select 1380 (e.g., determine) a setting by taking a picture, generating an image, and/or otherwise receiving an image to determine a setting of compressed air. As an example, a system (e.g., systems illustrated in FIGS. 1A-12C) may select 1380 (e.g., determine) a setting by using one or more user profile settings (e.g., user inputs).

As an example, selecting 1380 a setting is based, at least in part, on a type of projectile casing, an amount of debris (e.g., low, medium, high) in projectile casing, a desired amount of debris to retain in projectile casing (e.g., none, minimal, low, medium, and/or high), thickness of projectile casing, shape of projectile casing, an amount of previous cleaning (e.g., first time cleaning, second time cleaning, combination of methods and/or repetitions of compressed air), how many times projectile casing was previously used to fire a projectile, and/or other considerations described herein. As another example, an expert shooter may also input a desired amount (e.g., low, medium, high) of debris to retain in a projectile casing, such as to allow a moderate amount of carbon to remain to mask brass imperfections. To select 1380 an air compression setting, a process 1300 may include performing a neural network to determine an air setting (e.g., psi, direction, and/or other setting described herein) and/or generate instructions to use an air setting to clean a projectile casing. As an example, a neural network may generate one or more calculations, images, diagrams, models, and/or maps (e.g., velocity and/or pressure maps) to illustrate and/or predict air flow directed into a projectile casing. As an example, a neural network may use one or more generated calculations, images, diagrams, models, and/or maps (e.g., velocity and/or pressure maps) to model debris and air flow out of a projectile casing. As an example, computer vision may generate an image of a projectile casing and a neural network may generate an indication how much residue is on a projectile casing. A user and/or neural network may provide one or more indications to select 1380 a setting. As an example, a system performing process 1300 may receive an indication of the type of projectile casing and/or receive an indication of how much residue is on the projectile casing. In at least one embodiment, the neural network can be trained using labeled data of projectile casing, amount of residue, images of the projectile casing before and after firing, and statistics related to how accurate a projectile when used with a projectile casing. A neural network can be a convolution neural network, a transform, or a combination thereof.

At select 1380, for example, system 100 can perform this step dynamically. For example, system 100 can perform a process of cleaning projectile casings using compressed air by dynamically adjusting settings based on specific attributes of the casing to cause improved (e.g., optimal) cleaning performance for a variety of casing types and conditions. For example, system 100 can use sensors and control algorithms to assess attributes of each casing, such as material composition, caliber, degree of residue, and prior usage. Based on this assessment, system 100 modifies its settings prior to cleaning or in real-time to clean the projectile casing while reducing (e.g., minimizing wear on the casing).

To select 1380 an air compression setting, a process 1300 may determine a desired amount of debris in projectile casing (e.g., none or minimal to mask brass imperfections) and select a best air compression setting (e.g., referencing factory recommendations). As an example, one or more systems described in FIGS. 1A-12C selects 1380 an air compression setting to use with a type of projectile casing (e.g., shape of projectile casing corresponding to a type of projectile, amount of powder, and/or a type of projectile), such as by changing a component directed towards a type of projectile casing, adjusting an air pressure (e.g., 40-100 psi) entering a projectile casing, adjusting a direction air enters a projectile casing, and/or uses one or more controls associated with one or more settings of air compression. In at least one embodiment, system 100 selects an air pressure (e.g., 40, 50, 60, 70, or greater psi) based on the thickness and/or strength of material of the projectile casing (e.g., brass and 0.05 thickness will have a higher air pressure than brass 0.02 thickness). In at least one embodiment, a processor 1300 determines the compressed air setting to be a specific air pressure based, at least in part, on an air pressure that removes debris from the projectile casing and is not high enough to damage material of the projectile casing. For example, a look-up table used by the processor can include ranges for air pressure limits to prevent damage for different materials included in different projectile casings.

Once a system (e.g., one or more systems illustrated in FIGS. 1A-12C) performing process 1300 selects 1380 an air compression setting, a projectile casing may be inserted 1382 (e.g., into projectile casing cleaning component). At selection step 1382, system 100 or marksman may insert a projectile casing manually, automatically, using one or more devices, and/or by selecting a next projectile casing in a queue of one or more projectile casings. In at least one embodiment, a projectile casing may be inserted 1382 prior to selecting 1380 an air compression setting. In at least one embodiment, upon inserting a projectile casing 1382, a system performing process 1300 may release compressed air into a projectile casing at a selected air compression setting, such as by using one or more controls 112.

At release step 1384, a programmer, system 100, or marksman may release 1384 compressed air into a projectile casing at a selected setting, such as by using one or more controls 112. Air may be released 1384 using selected setting, such as setting selected based, at least in part, on a neural network. Air released 1384 may be at a direction determined using air flow calculations to remove debris from a type of projectile casing. Released 1384 compressed air may then carry debris out of projectile casing, such that a system performing process 1300 may catch 1386 debris exiting a projectile casing.

At catching step 1386, system 100 or marksman may catch debris exiting projectile casing, such as by using one or more debris traps and/or debris funnels. As an example, debris is caught from one or more projectile casings using a debris catch (e.g., debris catch 900, see FIG. 9). Upon debris exiting projectile casing, a system may repeat steps 1384 and 1386 until a projectile casing is determined to be cleaned and/or remove 1388 projectile casing from a device. At removal step 1388, system 100 or marksman may remove projectile casing, such as by extracting projectile casing manually and/or using one or more devices. As an example, a projectile casing is removed 1388 using system 1100 and/or 1200.

In at least one embodiment, some or all of process 1300 (or any other processes described herein, or variations and/or combinations thereof) is performed under control of one or more computer systems configured with computer executable instructions and is implemented as code (e.g., computer executable instructions, one or more computer programs, or one or more applications) executing collectively on one or more processors, by hardware, software, or combinations thereof. In at least one embodiment, code is stored on a computer-readable storage medium in form of a computer program comprising a plurality of computer-readable instructions executable by one or more processors. In at least one embodiment, a computer-readable storage medium is a non-transitory computer-readable medium. In at least one embodiment, at least some computer-readable instructions usable to perform process 1300 are not stored solely using transitory signals (e.g., a propagating transient electric or electromagnetic transmission). In at least one embodiment, a non-transitory computer-readable medium does not necessarily include non-transitory data storage circuitry (e.g., buffers, caches, and queues) within transceivers of transitory signals. In at least one embodiment, process 1300 is performed at least in part on a computer system such as those described elsewhere in this disclosure. In at least one embodiment, logic (e.g., hardware, software, or a combination of hardware and software) performs process 1300.

In at least one embodiment, process 1300 includes one or more steps to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings and/or otherwise perform operations described herein. In at least one embodiment, process 1300 is, is included in, and/or otherwise includes one or more processes illustrated in FIGS. 1A-12C, such as to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings and/or otherwise perform operations described herein. In at least one embodiment, one or more systems illustrated in FIGS. 1A-12C perform process 1300, such as to load automatically by a projectile casing cleaning system, a projectile casing into a holder to hold the projectile casing in place while it is being cleaned with compressed air; to receive, at the projectile casing cleaning system, a selection of an air compression setting, wherein the selection is at least partially based on a type of the projectile casing; to apply, by the projectile casing cleaning system, compressed air to the projectile casing to cause residue present on the projectile casing to be removed from the projectile; to capture particulates that were removed from the projectile casing in a filter of the projectile casing cleaning system; to unload, automatically by the projectile casing cleaning system, the projectile casing into an area for clean projectile casings and/or otherwise perform operations described herein.

A non-transitory computer-readable medium may store instructions that, when executed by one or more processors, cause the one or more processors to perform process 1300. As an example, a non-transitory computer-readable medium storing instructions that, when executed by one or more processors, cause the one or more processors to perform process 1300, such as to perform operations to: load, automatically by a projectile casing cleaning system, a projectile casing into a holder to hold the projectile casing in place while it is being cleaned with compressed air; receive, at the projectile casing cleaning system, a selection of an air compression setting, wherein the selection is at least partially based on a type of the projectile casing; apply, by the projectile casing cleaning system, compressed air to the projectile casing to cause residue present on the projectile casing to be removed from the projectile; capture particulates that were removed from the projectile casing in a filter of the projectile casing cleaning system; unload, automatically by the projectile casing cleaning system, the projectile casing into an area for clean projectile casings, and/or otherwise perform operations described herein.

What is claimed is:

1. A method to clean a projectile casing, the method comprising:
loading automatically, by a projectile casing cleaning system, a projectile casing into a holder to hold the projectile casing in place while it is being cleaned with compressed air;
receiving, at the projectile casing cleaning system, a selection of an air compression setting, wherein the selection is at least partially based on an attribute of the projectile casing;
applying automatically, by the projectile casing cleaning system, compressed air to the projectile casing to cause residue present on the projectile casing to be removed from the projectile in response to receiving the selection of the air compression setting;
capturing particulates that were removed from the projectile casing; and
unloading automatically, by the projectile casing cleaning system, the projectile casing into an area for clean projectile casings.

2. The method of claim 1, wherein an attribute of casing includes a caliber of casing.

3. The method of claim 1, wherein selecting an air compression setting includes receiving an electronic signal from one or more control buttons of the projectile casing system.

4. The method of claim 1, wherein the compressed air is to be released into a bottom of the projectile casing, wherein the bottom of the projectile casing is a location opposite of a neck of the projectile casing.

5. The method of claim 1, wherein the projectile casing cleaning system includes a debris catch to catch residue exiting the projectile casing in response to applying the compressed air to the projectile casing.

6. The method of claim 1, wherein applying the compressed air includes applying compressed air with a psi of 40-140 psi.

7. The method of claim 6, wherein receiving a selection of an air compression setting further includes:
receiving an indication of the type of projectile casing; and
receiving an indication of how much residue is on the projectile casing.

8. The method of claim 1, wherein a mesh catches debris exiting a casing.

9. The method of claim 1, wherein capturing particulates further includes a filter receiving expelled compressed air.

10. The method of claim 1, wherein applying the compressed air includes varying the pressure or velocity of compressed air such that the pressure or velocity of compressed air increased with time and then decreased before the cleaning is finished.

11. A non-transitory computer-readable medium storing instructions that, when executed by one or more processors, cause the one or more processors to perform operations to:
load, automatically by a projectile casing cleaning system, a projectile casing into a holder to hold the projectile casing in place while it is being cleaned with compressed air;
receive, at the projectile casing cleaning system, a selection of an air compression setting, wherein the selection is at least partially based on an attribute of the projectile casing;
apply, by the projectile casing cleaning system, compressed air to the projectile casing to cause residue present on the projectile casing to be removed from the projectile;
capture particulates that were removed from the projectile casing in a filter of the projectile casing cleaning system; and
unload, automatically by the projectile casing cleaning system, the projectile casing into an area for clean projectile casings.

12. The non-transitory computer-readable medium of claim 11, wherein to apply the compressed air includes to generate compressed air pressure from 40 to 60 pounds per square inch (psi).

13. The non-transitory computer-readable medium of claim 11, wherein the instructions, when executed by the one or more processors, further cause the one or more processors to select an air pressure for applying the compressed air based, at least in part, on a type of the projectile casing and/or images including residue on the projectile casing.

14. The non-transitory computer-readable medium of claim 11, wherein the filter of the projectile casing cleaning system includes mesh to prevent debris from exiting a debris catch.

15. The non-transitory computer-readable medium of claim 11, wherein the projectile casing cleaning system includes one or more components to rotate between one or more functions.

16. The non-transitory computer-readable medium of claim 15, wherein the one or more functions include removing a primer, cleaning a projectile casing, and removing a cleaned casing.

17. The non-transitory computer-readable medium of claim 11, wherein the selection of an air compression setting is at least partially based on an amount of carbon to retain indicated by a user.

18. A system to clean a projectile casing, the system comprising:
a primer extractor to remove a used primer from a projectile casing;
a cleaning component to apply compressed air to the projectile casing;
a projectile casing extractor to remove the projectile casing from the system after the used primer has been removed from the projectile casing;
an air compressor to generate compressed air for the cleaning component;
one or more air tubes to guide the compressed air, wherein the air tubes are coupled to the air compressor;
one or more debris tubes to receive the compressed air that has passed through the projectile casing;
one or more processors in electronic communication with primer extractor, projectile casing extractor, and the air compressor; and
memory storing instructions to perform operations that, when performed by the one or more processors, cause the system to remove a primer from the projectile casing, select a compressed air setting to apply to the projectile casing, and apply the compressed air to the projectile casing with the primer removed.

19. The system of claim 18, where the system further comprises: a staging rotator including one or more rotation components.

20. The system of claim 18, wherein the cleaning component further comprises: a nozzle to apply the compressed air to the projectile casing, air inlet, air outlet, debris catch, compressed air release attachment, one or more filters, and casing securing material.

21. The system of claim 18, where the primer extractor further comprises: a rod to remove the primer from the projectile casing.

22. The system of claim 18, where the projectile casing extractor further comprises: a rod to remove the projectile casing.

23. The system of claim 18, wherein the memory further stores instructions to use one or more neural networks to generate an air pressure setting and a length of time to apply compressed air based, at least in part, on images of the projectile casing.

24. The system of claim 18, further comprising:
a vacuum generator to generate a vacuum to apply to the projectile casing while compressed air is applied to the projectile casing; and
a chamber to apply a vacuum to the projectile casing.

25. The system of claim 18, wherein the memory further stores instructions, which when performed by the one or more processors, cause the properties of compressed air applied to the projectile casing to vary based, at least in part, on an attribute of the projectile casing.

26. The system of claim 18, wherein the memory further stores instructions to select the compressed air setting to be a specific air pressure based, at least in part, on an air pressure that removes debris from the projectile casing and is not high enough to damage material of the projectile casing.
